(19) United States
(12) Patent Application Publication
(10) Pub. No.: US 2017/0034819 A1
(43) Pub. Date: Feb. 2, 2017

(54) CONTROL CHANNEL RESOURCE ALLOCATION METHOD AND APPARATUS

(71) Applicant: HUAWEI TECHNOLOGIES CO., LTD., Shenzhen (CN)

(72) Inventors: Yi WANG, Shanghai (CN); Zhenfei Tang, Shanghai (CN); Zhongfeng Li, Shanghai (CN)

(73) Assignee: HUAWEI TECHNOLOGIES CO., LTD., Shenzhen (CN)

(21) Appl. No.: 15/290,289

(22) Filed: Oct. 11, 2016

Related U.S. Application Data
(63) Continuation of application No. PCT/CN2014/075211, filed on Apr. 11, 2014.

(51) Int. Cl. H04W 72/04; H04L 1/18

(52) U.S. Cl. CPC H04W 72/0446; H04L 1/1812; H04W 72/042

(57) ABSTRACT

The present invention relates to the field of mobile communications technologies, and in particular, to a control channel resource allocation method and apparatus. The method includes: sending, by user equipment UE, a physical uplink shared channel PUSCH in a current special subframe; determining, by the UE according to an uplink resource used to transmit the PUSCH, a physical hybrid automatic repeat request indicator channel PHICH resource corresponding to the PUSCH, where the uplink resource used to transmit the PUSCH includes the current special subframe; and receiving a PHICH on the determined PHICH resource. By means of the method and the apparatus that are provided in the present invention, a problem that when a special subframe is used to transmit an uplink PUSCH, there is no specific solution to determining a receiving position of a downlink PHICH corresponding to the uplink PUSCH is resolved.

### CROSS-REFERENCE TO RELATED APPLICATIONS

This application is a continuation of International Application No. PCT/CN2014/075211, filed on Apr. 11, 2014, the disclosure of which is hereby incorporated by reference in its entirety.

### TECHNICAL FIELD

The present invention relates to the field of mobile communications technologies, and in particular, to a control channel resource allocation method and apparatus.

### BACKGROUND

A time division multiplexing manner is used for uplink transmission of a TDD (time division duplex) system.

An LTE (Long Term Evolution) TDD system defines seven uplink-downlink subframe configurations, which are specifically shown in Table 1. Different uplink-downlink subframe configurations may be applied to scenarios having different uplink-downlink service requirements.

TABLE 1

| Uplink-downlink | | | | | | | | | | |
|---|---|---|---|---|---|---|---|---|---|---|
| subframe | Subframe number | | | | | | | | | |
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

Subframes of the TDD system may be classified into three types: an uplink subframe, a downlink subframe, and a special subframe. In Table 1, D represents a downlink subframe, S represents a special subframe, and U represents an uplink subframe. It can be known from Table 1 that, in the TDD system, in one radio frame, some subframes are uplink subframes, and some subframes are downlink subframes. In other words, a part of duration of one radio frame is used for uplink transmission, and a part of duration is used for downlink transmission.

A structure of a special subframe is shown in FIG. 1. The special subframe includes three parts: a DwPTS (downlink pilot time slot), a guard period (guard period), and a UpPTS (uplink pilot time slot). Specifically, the DwPTS is used for downlink transmission, for example, transmission of a control channel, a data channel, a synchronization signal, and a pilot signal. The GP is used as a guard period, and is not used for uplink or downlink transmission. The UpPTS is used to transmit an uplink SRS (sounding reference signal) or PRACH (physical random access channel).

In the TDD system, a part of duration of one radio frame is used for uplink transmission, and a part of duration is used for downlink transmission. Because uplink and downlink subframes work in a time division duplex manner, for UE (user equipment), a quantity of subframes that can be used for uplink data transmission is limited. In other words, the time division manner may cause a small uplink throughput (a data transmission amount per unit time) of the system.

### SUMMARY

Embodiments of the present invention provide a control channel resource allocation method and apparatus, to resolve a problem in the prior art that a time division manner causes a small uplink throughput of a system.

According to a first aspect, a control channel resource allocation method is provided, where the method includes:

sending, by user equipment UE, a physical uplink shared channel PUSCH in a current special subframe;

determining, by the UE according to an uplink resource used to transmit the PUSCH, a physical hybrid automatic repeat request indicator channel PHICH resource corresponding to the PUSCH, where the uplink resource used to transmit the PUSCH includes the current special subframe; and

receiving, by the UE, a PHICH on the determined PHICH resource.

With reference to the first aspect, in a first possible implementation manner, the determining, by the UE according to an uplink resource used to transmit the PUSCH, a PHICH resource corresponding to the PUSCH includes:

determining, by the UE according to the uplink resource used to transmit the PUSCH, a subframe position of the PHICH resource corresponding to the PUSCH; and

determining a PHICH group number of the PHICH resource according to the subframe position, and determining, according to the subframe position and the PHICH group number, the PHICH resource corresponding to the PUSCH.

With reference to the first possible implementation manner of the first aspect, in a second possible implementation manner, when a subframe of the uplink resource used to transmit the PUSCH is only the current special subframe, the determining, by the UE according to the uplink resource used to transmit the PUSCH, a subframe position of the PHICH resource corresponding to the PUSCH includes:

when an uplink-downlink subframe configuration is 0 and the current special subframe is a subframe n, determining that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determining that the PHICH resource is located in the K^{th} subframe after the current special subframe n, where when n=1 or 6, K=4; when n=1 or 6, K=5; or when n=1 or 6, K=8; or

when an uplink-downlink subframe configuration is 2 and the current special subframe is a subframe n, determining that the PHICH resource is located in the K^{th} subframe after the current special subframe n, where when n=1 or 6, K=4; when n=1 or 6, K=5; when n=1 or 6, K=7; or when n=1 or 6, K=8; or

when an uplink-downlink subframe configuration is 3 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determining that the PHICH resource is located in the K^{th} subframe after the current special subframe n, where

when n=1 or 6, K=4;

when n=1 or 6, K=5;

when n=1 or 6, K=8;

when n=1 or 6, K =9; or

when n=1 or 6, K=10.

With reference to the first possible implementation manner of the first aspect, in a third possible implementation manner, when a subframe of the uplink resource used to transmit the PUSCH includes the current special subframe and a coordination subframe bundled with the current special subframe, the determining, by the UE according to the uplink resource used to transmit the PUSCH, a subframe position of the PHICH resource corresponding to the PUSCH includes:

determining, according to the coordination subframe, the subframe position of the PHICH resource corresponding to the PUSCH.

With reference to the third possible implementation manner of the first aspect, in a fourth possible implementation manner, the coordination subframe includes at least one uplink subframe in a radio frame of the current special subframe and/or another special subframe in the radio frame except the current special subframe.

With reference to the third or fourth possible implementation manner of the first aspect, in a fifth possible implementation manner, the determining, by the UE according to the uplink resource used to transmit the PUSCH, a subframe position of the PHICH resource corresponding to the PUSCH includes:

determining, according to the last subframe L in the coordination subframe, the subframe position of the PHICH resource corresponding to the PUSCH.

With reference to the fifth possible implementation manner of the first aspect, in a sixth possible implementation manner, the determining, according to the last subframe L in the coordination subframe, the subframe position of the PHICH resource corresponding to the PUSCH includes:

if an uplink-downlink subframe configuration is 0, when special subframes 1 and 6 in a radio frame are bundled with subframes 2, 3, 4, 7, 8, and 9 in the radio frame, determining that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determining that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determining that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determining that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determining that the PHICH resource is located in the K^{th} subframe after the subframe 2, where K=5, 15, or 25; or

if an uplink-downlink subframe configuration is 6, when special subframes 1 and 6 in a radio frame are bundled with subframes 2, 3, 4, 7, and 8 in the radio frame, determining that the PHICH resource is located in the K^{th} subframe after the last subframe L, where L=8 and K=17.

With reference to the fifth possible implementation manner of the first aspect, in a seventh possible implementation manner, if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the determining, according to the last subframe L in the coordination subframe, the subframe position of the PHICH resource corresponding to the PUSCH includes:

a first PHICH resource corresponding to the first bundle frame is located in the K1^{th} subframe after the last subframe L, where L=2 and K1=4; and

a second PHICH resource corresponding to the second bundle frame is located in the K2^{th} subframe after the last subframe L, where L=7 and K2=4.

With reference to the fifth possible implementation manner of the first aspect, in an eighth possible implementation manner, if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the determining, according to the last subframe L in the coordination subframe, the subframe position of the PHICH resource corresponding to the PUSCH includes:

a first PHICH resource corresponding to the first bundle frame is located in the K^{th} subframe after the last subframe L, where L=3 and K=6;

a second PHICH resource corresponding to the second bundle frame is located in the K^{th} subframe after the last subframe L, where L=2 and K=6; and

a third PHICH resource corresponding to the third bundle frame is located in the K^{th} subframe after the last subframe L, where L=4 and K=6.

With reference to any one of the first to eighth possible implementation manners of the first aspect, in a ninth possible implementation manner, the determining a PHICH group number of the PHICH resource according to the subframe position includes:

determining, according to the subframe position corresponding to the PHICH resource and by using a PHICH group number indication factor I_{PHICH}, the PHICH group number corresponding to the PUSCH.

With reference to ninth possible implementation manner of the first aspect, in a tenth possible implementation manner, the determining a PHICH group number of the PHICH resource according to the subframe position includes:

when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determining, by using the determined I_{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determining, by using the determined I_{PHICH}, the PHICH group number corresponding to the PUSCH.

With reference to ninth possible implementation manner of the first aspect, in an eleventh possible implementation manner, the determining a PHICH group number of the PHICH resource according to the subframe position includes:

when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 6 and 8 are 1, and I_{PHICH} corresponding to another subframe in the radio frame of the current special subframe except the subframes 6 and 8 is 0, and determining, by using the determined I_{PHICH}, the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 1 and 4 are 1, and I_{PHICH} corresponding to another subframe in the radio frame of the current special subframe except the subframes 1 and 4 is 0, and determining, by using the determined I_{PHICH}, the PHICH group number corresponding to the PUSCH.

According to a second aspect, a control channel resource allocation method is provided, where the method includes:

receiving, by a base station, a physical uplink shared channel PUSCH in a current special subframe;

determining, by the base station according to an uplink resource used to receive the PUSCH, a physical hybrid automatic repeat request indicator channel PHICH resource corresponding to the PUSCH, where the uplink resource includes the current special subframe; and

transmitting, by the base station, a PHICH on the determined PHICH resource.

With reference to the second aspect, in a first possible implementation manner, the determining, by the base station according to an uplink resource used to receive the PUSCH, a PHICH resource corresponding to the PUSCH includes:

determining, by the base station according to the uplink resource used to receive the PUSCH, a subframe position of the PHICH resource corresponding to the PUSCH; and

determining a PHICH group number of the PHICH resource according to the subframe position, and determining, according to the subframe position and the PHICH group number, the PHICH resource corresponding to the PUSCH.

With reference to the first possible implementation manner of the second aspect, in a second possible implementation manner, when a subframe of the uplink resource used to transmit the PUSCH is only the current special subframe, the determining, by the base station according to the uplink resource used to receive the PUSCH, a subframe position of the PHICH resource corresponding to the PUSCH includes:

when an uplink-downlink subframe configuration is 0 and the current special subframe is a subframe n, determining that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determining that the PHICH resource is located in the K^{th} subframe after the current special subframe n, where when n=1 or 6, K=4; when n=1 or 6, K=5; or when n=1 or 6, K=8; or

when an uplink-downlink subframe configuration is 2 and the current special subframe is a subframe n, determining that the PHICH resource is located in the K^{th} subframe after the current special subframe n, where when n=1 or 6, K=4; when n=1 or 6, K=5; when n=1 or 6, K=7; or when n=1 or 6, K=8; or

when an uplink-downlink subframe configuration is 3 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determining that the PHICH resource is located in the K^{th}subframe after the current special subframe n, where when n=1, K=4, 5, 6, 7, 8, or 9; or

when an uplink-downlink subframe configuration is 5 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determining that the PHICH resource is located in the K^{th} subframe after the current special subframe n, where

when n=1 or 6, K=4;

when n=1 or 6, K=5;

when n=1 or 6, K=8;

when n=1 or 6, K=9; or

when n=1 or 6, K=10.

With reference to the first possible implementation manner of the second aspect, in a third possible implementation manner, when a subframe of the uplink resource used to transmit the PUSCH includes the current special subframe and a coordination subframe bundled with the current special subframe, the determining, by the base station according to the uplink resource used to receive the PUSCH, a subframe position of the PHICH resource corresponding to the PUSCH includes:

determining, according to the coordination subframe, the subframe position of the PHICH resource corresponding to the PUSCH.

With reference to the third possible implementation manner of the second aspect, in a fourth possible implementation manner, the coordination subframe includes at least one uplink subframe in a radio frame of the current special subframe and/or another special subframe in the radio frame except the current special subframe.

With reference to the third or fourth possible implementation manner of the second aspect, in a fifth possible implementation manner, the determining, by the base station according to the uplink resource used to receive the PUSCH, a subframe position of the PHICH resource corresponding to the PUSCH includes:

determining, according to the last subframe L in the coordination subframe, the subframe position of the PHICH resource corresponding to the PUSCH.

With reference to the fifth possible implementation manner of the second aspect, in a sixth possible implementation manner, the determining, according to the last subframe L in the coordination subframe, the subframe position of the PHICH resource corresponding to the PUSCH includes:

if an uplink-downlink subframe configuration is 0, when special subframes 1 and 6 in a radio frame are bundled with subframes 2, 3, 4, 7, 8, and 9 in the radio frame, determining that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determining that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determining that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determining that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determining that the PHICH resource is located in the K^{th} subframe after the subframe 2, where K=5, 15, or 25; or

if an uplink-downlink subframe configuration is 6, when special subframes 1 and 6 in a radio frame are bundled with subframes 2, 3, 4, 7, and 8 in the radio frame, determining that the PHICH resource is located in the K^{th} subframe after the last subframe L, where L=8 and K=17.

With reference to the fifth possible implementation manner of the second aspect, in a seventh possible implementation manner, if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the determining, according to the last subframe L in the coordination subframe, the subframe position of the PHICH resource corresponding to the PUSCH includes:

a first PHICH resource corresponding to the first bundle frame is located in the K1^{th} subframe after the last subframe L, where L=2 and K1=4; and

a second PHICH resource corresponding to the second bundle frame is located in the K2^{th} subframe after the last subframe L, where L=7 and K2=4.

With reference to the fifth possible implementation manner of the second aspect, in an eighth possible implementation manner, if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the determining, according to the last subframe L in the coordination subframe, the subframe position of the PHICH resource corresponding to the PUSCH includes:

a first PHICH resource corresponding to the first bundle frame is located in the K^{th} subframe after the last subframe L, where L=3 and K=6;

a second PHICH resource corresponding to the second bundle frame is located in the K^{th} subframe after the last subframe L, where L=2 and K=6; and

a third PHICH resource corresponding to the third bundle frame is located in the K^{th} subframe after the last subframe L, where L=4 and K=6.

With reference to any one of the first to eighth possible implementation manners of the second aspect, in a ninth possible implementation manner, the determining a PHICH group number of the PHICH resource according to the subframe position includes: determining, according to the subframe position corresponding to the PHICH resource and by using a PHICH group number indication factor I_{PHICH}, the PHICH group number corresponding to the PUSCH.

With reference to ninth possible implementation manner of the second aspect, in a tenth possible implementation manner, the determining a PHICH group number of the PHICH resource according to the subframe position includes:

when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determining, by using the determined I_{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determining, by using the determined I_{PHICH}, the PHICH group number corresponding to the PUSCH.

With reference to ninth possible implementation manner of the second aspect, in an eleventh possible implementation manner, the determining a PHICH group number of the PHICH resource according to the subframe position includes:

when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 6 and 8 are 1, and I_{PHICH} corresponding to another subframe in the radio frame of the current special subframe except the subframes 6 and 8 is 0, and determining, by using the determined I_{PHICH} the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 1 and 4 are 1, and I_{PHICH} corresponding to another subframe in the radio frame of the current special subframe except the subframes 1 and 4 is 0, and determining, by

using the determined I_{PHICH} , the PHICH group number corresponding to the PUSCH.

According to a third aspect, user equipment is provided, where the user equipment includes:

a sending unit, configured to send a physical uplink shared channel PUSCH in a current special subframe;

a determining unit, configured to determine, according to an uplink resource used to transmit the PUSCH, a physical hybrid automatic repeat request indicator channel PHICH resource corresponding to the PUSCH, where the uplink resource used to transmit the PUSCH includes the current special subframe; and

a receiving unit, configured to receive a PHICH on the determined PHICH resource.

With reference to the third aspect, in a first possible implementation manner, the determining unit specifically includes:

a subframe position determining module, configured to determine, according to the uplink resource used to transmit the PUSCH, a subframe position of the PHICH resource corresponding to the PUSCH; and

a resource group number determining module, configured to determine a PHICH group number of the PHICH resource according to the subframe position, and determine, according to the subframe position and the PHICH group number, the PHICH resource corresponding to the PUSCH.

With reference to the first possible implementation manner of the third aspect, in a second possible implementation, when a subframe of the uplink resource used to transmit the PUSCH is only the current special subframe, the subframe position determining module is further configured to:

when an uplink-downlink subframe configuration is 0 and the current special subframe is a subframe n, determine that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determine that the PHICH resource is located in the K^{th} subframe after the current special subframe n, where when n=1 or 6, K=4; when n=1 or 6, K=5; or when n=1 or 6, K=8; or

when an uplink-downlink subframe configuration is 2 and the current special subframe is a subframe n, determine that the PHICH resource is located in the K^{th} subframe after the current special subframe n, where when n=1 or 6, K=4; when n=1 or 6, K=5; when n=1 or 6, K=7; or when n=1 or 6, K=8; or

when an uplink-downlink subframe configuration is 3 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determine that the PHICH resource is located in the K^{th} subframe after the current special subframe n, where

when n=1 or 6, K=4;

when n=1 or 6, K=5;

when n=1 or 6, K=8;

when n=1 or 6, K=9; or

when n=1 or 6, K=10.

With reference to the first possible implementation manner of the third aspect, in a third possible implementation manner, when a subframe of the uplink resource used to transmit the PUSCH includes the current special subframe and a coordination subframe bundled with the current special subframe, the subframe position determining module is further configured to determine, according to the coordination subframe, the subframe position of the PHICH resource corresponding to the PUSCH.

With reference to the third possible implementation manner of the third aspect, in a fourth possible implementation manner, the subframe position determining module is further configured to determine, by using at least one uplink subframe, in a radio frame of the current special subframe, included in the coordination subframe and/or another special subframe, in the radio frame except the current special subframe, included in the coordination subframe, the subframe position of the PHICH resource corresponding to the PUSCH.

With reference to the third or fourth possible implementation manner of the third aspect, in a fifth possible implementation manner, the subframe position determining module is further configured to determine, according to the last subframe L in the coordination subframe, the subframe position of the PHICH resource corresponding to the PUSCH.

With reference to the fifth possible implementation manner of the third aspect, in a sixth possible implementation manner, the subframe position determining module is further configured to:

if an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determine that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determine that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determine that the PHICH resource is located in the K^{th} subframe after the last subframe L, where L=2 and K=5, 15, or 25; or

if an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, where L=8 and K=17.

With reference to the fifth possible implementation manner of the third aspect, in a seventh possible implementation manner, if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the subframe position determining module is further configured to:

determine that a first PHICH resource corresponding to the first bundle frame is located in the K1^{th} subframe after the last subframe L, where L=2 and K1=4; and

determine that a second PHICH resource corresponding to the second bundle frame is located in the K2^{th} subframe after the last subframe L, where L=7 and K2=4.

With reference to the fifth possible implementation manner of the third aspect, in an eighth possible implementation manner, if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the subframe position determining module is further configured to:

determine that a first PHICH resource corresponding to the first bundle frame is located in the K^{th} subframe after the last subframe L, where L=3 and K=6;

determine that a second PHICH resource corresponding to the second bundle frame is located in the K^{th} subframe after the last subframe L, where L=2 and K=6; and

determine that a third PHICH resource corresponding to the third bundle frame is located in the K^{th} subframe after the last subframe L, where L=4 and K=6.

With reference to any one of the first to eighth possible implementation manners of the third aspect, in a ninth possible implementation manner, the resource group number determining module is further configured to determine, according to the subframe position corresponding to the PHICH resource and by using a PHICH group number indication factor I_{PHICH}, the PHICH group number corresponding to the PUSCH.

With reference to the ninth possible implementation manner of the third aspect, in a tenth possible implementation manner, the resource group number determining module is further configured to:

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determine, by using the determined I_{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determine, by using the determined I_{PHICH,} the PHICH group number corresponding to the PUSCH.

With reference to the ninth possible implementation manner of the third aspect, in an eleventh possible implementation manner, the resource group number determining module is further configured to:

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 6 and 8 are 1, and I_{PHICH} corresponding to another subframe in the radio frame of the current special subframe except the subframes 6 and 8 is 0, and determine, by using the determined I_{PHICH}, the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 1 and 4 are 1, and I_{PHICH} corresponding to another subframe in the radio frame of the current special subframe except the subframes 1 and 4 is 0, and determine, by using the determined I_{PHICH}, the PHICH group number corresponding to the PUSCH.

According to a fourth aspect, a base station is provided, where the base station includes:

a receiving unit, configured to receive a physical uplink shared channel PUSCH in a current special subframe;

a determining unit, configured to determine, according to an uplink resource used to receive the PUSCH, a physical hybrid automatic repeat request indicator channel PHICH resource corresponding to the PUSCH, where the uplink resource includes the current special subframe; and

a transmission unit, configured to transmit a PHICH on the determined PHICH resource.

With reference to the fourth aspect, in a first possible implementation manner, the determining unit includes:

a subframe position determining module, configured to determine, according to the uplink resource used to receive the PUSCH, a subframe position of the PHICH resource corresponding to the PUSCH; and

a resource group number determining module, configured to determine a PHICH group number of the PHICH resource according to the subframe position, and determine, according to the subframe position and the PHICH group number, the PHICH resource corresponding to the PUSCH.

With reference to the first possible implementation manner of the fourth aspect, in a second possible implementation, when a subframe of the uplink resource used to transmit the PUSCH is only the current special subframe, the subframe position determining module is further configured to:

when an uplink-downlink subframe configuration is 0 and the current special subframe is a subframe n, determine that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determine that the PHICH resource is located in the K^{th} subframe after the current special subframe n, where when n=1 or 6, K=4; when n=1 or 6, K=5; or when n=1 or 6, K=8; or

when an uplink-downlink subframe configuration is 2 and the current special subframe is a subframe n, determine that the PHICH resource is located in the K^{th} subframe after the current special subframe n, where when n=1 or 6, K=4; when n=1 or 6, K=5; when n=1 or 6, K=7; or when n=1 or 6, K=8; or

when an uplink-downlink subframe configuration is 3 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determine that the PHICH resource is located in the K^{th} subframe after the current special subframe n, where

when n=1 or 6, K=4;

when n=1 or 6, K=5;

when n=1 or 6, K=8;

when n=1 or 6, K =9; or

when n=1 or 6, K=10.

With reference to the first possible implementation manner of the fourth aspect, in a third possible implementation manner, when a subframe of the uplink resource used to transmit the PUSCH includes the current special subframe and a coordination subframe bundled with the current special subframe, the subframe position determining module is further configured to determine, according to the coordination subframe, the subframe position of the PHICH resource corresponding to the PUSCH.

With reference to the third possible implementation manner of the fourth aspect, in a fourth possible implementation manner, the subframe position determining module is further configured to determine, by using at least one uplink subframe, in a radio frame of the current special subframe, included in the coordination subframe and/or another special subframe in the radio frame except the current special subframe, the subframe position of the PHICH resource corresponding to the PUSCH.

With reference to the third or fourth possible implementation manner of the fourth aspect, in a fifth possible implementation manner, the subframe position determining module is further configured to determine, according to the last subframe L in the coordination subframe, the subframe position of the PHICH resource corresponding to the PUSCH.

With reference to the fifth possible implementation manner of the fourth aspect, in a sixth possible implementation manner, the subframe position determining module is further configured to:

if an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determine that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determine that the PHICH resource is located in the K^{th} subframe after the last subframe L, where L=4 and K=16; or if an uplink-downlink subframe configuration is 5, when a special subframe 1 in a radio frame is bundled with a subframe 2 in the radio frame, determine that the PHICH resource is located in the K^{th} subframe after the last subframe L, where L=2 and K=5, 15, or 25; or

if an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, where L=8 and K=17.

With reference to the fifth possible implementation manner of the fourth aspect, in a seventh possible implementation manner, if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the subframe position determining module is further configured to:

determine that a first PHICH resource corresponding to the first bundle frame is located in the K2^{th} subframe after the last subframe L, where L=2 and K1=4; and

determine that a second PHICH resource corresponding to the second bundle frame is located in the K2^{th} subframe after the last subframe L, where L=7 and K2=4.

With reference to the fifth possible implementation manner of the fourth aspect, in an eighth possible implementation manner, if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the subframe position determining module is further configured to:

determine that a first PHICH resource corresponding to the first bundle frame is located in the K^{th} subframe after the last subframe L, where L=3 and K=6;

determine that a second PHICH resource corresponding to the second bundle frame is located in the K^{th} subframe after the last subframe L, where L=2 and K=6; and

determine that a third PHICH resource corresponding to the third bundle frame is located in the K^{th} subframe after the last subframe L, where L=4 and K=6.

With reference to any one of the first to eighth possible implementation manners of the fourth aspect, in a ninth possible implementation manner, the resource group number determining module is further configured to determine, according to the subframe position corresponding to the PHICH resource and by using a PHICH group number indication factor I_{PHICH}, the PHICH group number corresponding to the PUSCH.

With reference to the ninth possible implementation manner of the fourth aspect, in a tenth possible implementation manner, the resource group number determining module is further configured to:

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determine, by using the determined I_{PHICH} , the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determine, by using the determined I_{PHICH}, the PHICH group number corresponding to the PUSCH.

With reference to the ninth possible implementation manner of the fourth aspect, in an eleventh possible implementation manner, the resource group number determining module is further configured to:

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 6 and 8 are 1, and I_{PHICH} corresponding to another subframe in the radio frame of the current special subframe except the subframes 6 and 8 is 0, and determine, by using the determined I_{PHICH}, the PHICH group number corresponding to the PUSCH; or when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 1 and 4 are 1, and I_{PHICH} corresponding to another subframe in the radio frame of the current special subframe except the subframes 1 and 4 is 0, and determine, by using the determined I_{PHICH}, the PHICH group number corresponding to the PUSCH.

In the method and the apparatus that are provided in the present invention, a UpPTS is used to transmit a PUSCH, which is equivalent to increasing an uplink data transmission amount within unit time, thereby increasing an uplink system throughput of a TDD system.

In addition, when a receiving position of a downlink PHICH is determined, a method for adjusting a PHICH group number corresponding to a PHICH resource is further provided, thereby providing a method for resolving a conflict between a PHICH resource corresponding to a newly determined PUSCH and an original configuration.

### BRIEF DESCRIPTION OF DRAWINGS

FIG. 1 is a schematic structural diagram of a special subframe in the prior art;

FIG. 2 is a schematic flowchart of a control channel resource allocation method according to Embodiment 1 of the present invention;

FIG. 3 is a schematic flowchart of a method for determining a PHICH resource corresponding to a PUSCH according to an embodiment of the present invention;

FIG. 4 is a schematic flowchart of a control channel resource allocation method according to Embodiment 4 of the present invention;

FIG. 5 is a schematic structural diagram of user equipment according to an embodiment of the present invention; and

FIG. 6 is a schematic structural diagram of a base station according to an embodiment of the present invention.

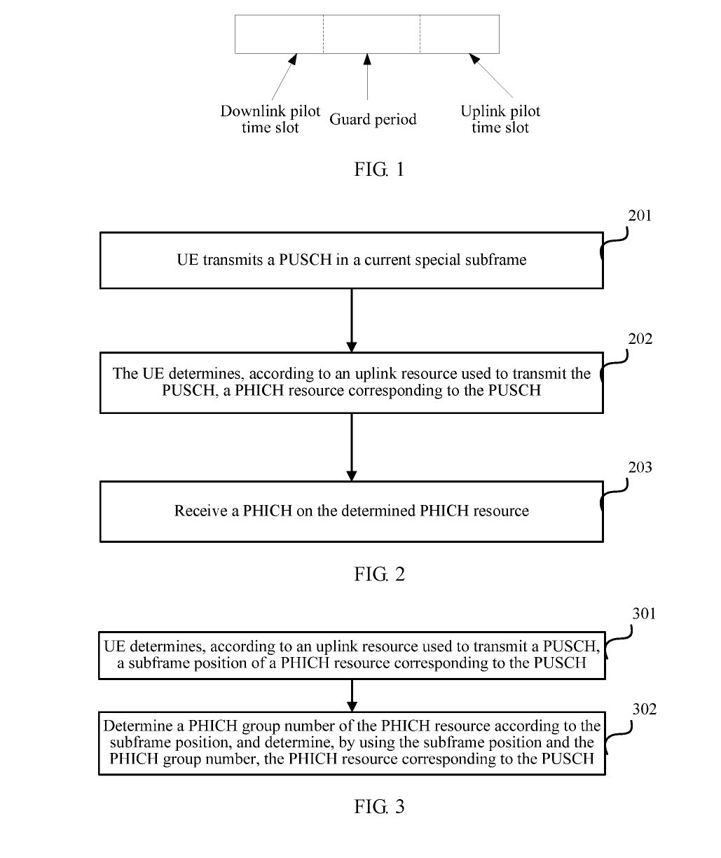

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

In a TDD system, because uplink and downlink subframes work in a time division duplex manner, for UE, a quantity of subframes that can be used for uplink data transmission is limited. For this problem, an implementable solution is: on condition that a total length 1 ms of special subframes is not changed, a quantity of UpPTS symbols is increased by changing a length of a special timeslot GP and a length of the UpPTS, an additional resource may be obtained from the UpPTS to transmit an uplink PUSCH (Physical Uplink Shared Channel, physical uplink shared channel), that is, transmit uplink data.

In a method for transmitting an uplink PUSCH by using a special subframe, an ACK/HACK-based HARQ (Hybrid Automatic Repeat Request, hybrid automatic repeat request) technology also needs to be used to improve the decoding accuracy. Based on the foregoing case, the method provided in the embodiments of the present invention provides a solution, to determine position allocation and a time frequency resource of a downlink PHICH (Physical Hybrid-ARQ Indicator Channel, physical hybrid-ARQ indicator channel) corresponding to a special subframe used to transmit uplink data.

### Embodiment 1

As shown in FIG. 2, for the foregoing problem, this embodiment of the present invention provides a control channel resource allocation method. The method includes:

Step 201: UE (user equipment) sends a PUSCH (physical uplink shared channel) in a current special subframe.

Using a special subframe for transmission refers to: using a UpPTS (uplink pilot time slot) in the special subframe as a subframe used to transmit uplink data.

Step 202: The UE determines, according to an uplink resource used to transmit the PUSCH, a PHICH resource corresponding to the PUSCH, where the uplink resource used to transmit the PUSCH includes the current special subframe.

In this embodiment of the present invention, the uplink resource used to transmit the PUSCH includes a UpPTS used to transmit the PUSCH, or may include an uplink subframe (or referred to an uplink normal subframe). A specific case may be: A: the uplink resource may be a UpPTS in one special subframe; B: the uplink resource may be UpPTSs in multiple special subframes, for example, two UpPTSs in one radio frame; C, the uplink resource may also include at least one UpPTS and at least one uplink subframe. In the foregoing B and C, the uplink resource is distributed in multiple subframes, and the multiple subframes may be referred to as a bundle subframe.

Step 203: Receive a PHICH on the determined PHICH resource.

Because the existing LTE system uses an ACK/NACK-based HARQ technology, a specific HARQ process of an uplink path is: a transmit end UE pauses after sending a data packet to a receive end eNB by using a PUSCH channel, and waits for a response message of the eNB. After the data packet arrives at the receive end eNB after a particular transmission delay, the eNB verifies the data packet. If the receiving is correct, the receive end feeds back an acknowledgment (ACK) message by using a downlink control channel PHICH, and if the receiving is incorrect, the receive end reserves the received desired information, and feeds back a non-acknowledgment (NACK) message. When receiving the ACK message, the UE sends new data; otherwise, the UE resends the previously-transmitted data packet, and the eNB combines the retransmitted data packet and the previously received data packet and performs joint decoding, thereby improving the decoding accuracy.

A process from when the UE transmits an uplink PUSCH and the eNB processes the uplink PUSCH and feeds back a downlink PHICH to when the UE receives and process the PHICH information and retransmits the PUSCH or transmits a new PUSCH refers to as an RTT (round trip time, round trip time) of one HARQ process. Considering a transmission delay and eNB processing time, a time from when the uplink PUSCH is sent to when the downlink PHICH is received should not be less than 4 ms; likewise, considering a transmission delay and UE processing time, a time from when the downlink PHICH is received to when a new uplink PUSCH is transmitted or the uplink PUSCH is retransmitted should be not less than 4 ms. An RTT value is not less than 8 ms.

Based on the uplink resource used to transmit the PUSCH, there may be multiple combinations and features of the HARQ technology, in this embodiment of the present invention, there may be multiple manners used to determine, according to the uplink resource used to transmit the PUSCH, the PHICH resource corresponding to the PUSCH. During specific implementation, main rules are:

a time from when a PHICH is received to when a PUSCH is transmitted and a time from when the PUSCH is transmitted to when a feedback PHICH is received are minimized, and satisfy a requirement of the base station or the UE for a smallest processing time, for example, 3 ms;

it is avoided as far as possible that PHICH resources in one subframe correspond to different HARQ processes; and

a current RTT value (a time from when a data packet is transmitted for the first time to when the data packet is retransmitted) is reused as far as possible or an additional RTT value as smaller as possible is added.

The foregoing rules are merely used as a reference when a UpPTS is used to transmit a PUSCH, and do not need to be satisfied necessarily. Specifically, when the UpPTS is used to transmit the PUSCH, only some rules of the foregoing rules may be considered, for example, only a rule involving an RTT is considered, or rules involving an RTT and an HARQ process are considered. Under the guidance of the foregoing rules, specific implementation steps of determining, by the UE according to an uplink resource used to transmit the PUSCH, a PHICH resource corresponding to the PUSCH in step 102 include (as shown in FIG. 3):

Step 301: The UE determines, according to the uplink resource used to transmit the PUSCH, a subframe position of the PHICH resource corresponding to the PUSCH.

Step 302: Determine a PHICH group number of the PHICH resource according to the subframe position, and determine, according to the subframe position and the PHICH group number, the PHICH resource corresponding to the PUSCH.

According to the foregoing method, the following describes in detail the method provided in this embodiment of the present invention with reference to tables and various uplink-downlink subframe configurations.

I. When a subframe of the uplink resource used to transmit the PUSCH is only the current special subframe, the determining, by the UE according to the uplink resource used to transmit the PUSCH, a subframe position of the PHICH resource corresponding to the PUSCH includes:

Specifically, with reference to seven uplink-downlink subframe configurations that are defined in an LTE TDD system and that are shown in Table 1, the following describes in detail an implementable solution of the PHICH resource in each configuration.

1. When an uplink-downlink subframe configuration is 0 and the current special subframe is a subframe n, determine that the PHICH resource is located in the K^{th} subframe after the current special subframe n, where

when n=1 or 6, K =5; or

when n=1 or 6, K=10.

Specifically, when the user equipment UE transmits the PUSCH in special subframe 1 or 6, correspondingly, it is determined that the PHICH resource is located in the K^{th} subframe after the special subframe 1 or 6, where specific optional values of K may be shown in Table 2:

TABLE 2

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | U | D | S | U | U | U |
| configuration 0 | | | | | | | | | | |
| K1 = 5 | | 5 | | | | | 5 | | | |
| K2 = 10 | | 10 | | | | | 10 | | | |

In a specific subframe structure, for an UL/DL configuration 0 (uplink-downlink subframe configuration 0):

A. As shown in Table 2, in a case in which K1=5, for a PUSCH transmitted in a special subframe n=1, the UE receives corresponding HARQ downlink PHICH feedback information (that is, receives the PHICH on the determined PHICH resource) in the fifth subframe (a value corresponding to a cross point of line 4 and column 3 in Table 2) after the subframe n=1, that is, receives, in a subframe n=6, the HARQ downlink PHICH feedback information corresponding to the PUSCH; for a PUSCH transmitted in the subframe n=6, the UE receives corresponding HARQ downlink PHICH feedback information (that is, the UE receives, in a subframe n=1, the HARQ downlink PHICH feedback information corresponding to the PUSCH) in the fifth subframe (a value corresponding to a cross point of line 4 and column 8 in Table 2) after the subframe 6.

B. As shown in Table 2, in a case in which K2=10, for a PUSCH transmitted in a special subframe n=1, the UE receives corresponding HARQ downlink PHICH feedback information (that is, receives the PHICH on the determined PHICH resource) in the 10^{th} subframe after the subframe n=1, that is, receives, in a subframe n=1 in a next radio frame, the HARQ downlink PHICH feedback information corresponding to the PUSCH; for a PUSCH transmitted in a subframe n=6, the UE receives, in a subframe n=6 in the next radio frame, the HARQ downlink PHICH feedback information corresponding to the PUSCH.

In the foregoing embodiment, it is determined that the PHICH resource is located in the fifth or 10^{th} subframe after the current special subframe. Therefore, a case in which more than two PHICHs are received in one subframe is avoided, a smallest change is made to the existing protocol, and meanwhile, a time interval from when a PUSCH is transmitted to a PHICH is received satisfies a smallest processing time of the base station and a transmission delay is relatively small, or a time interval from when a PHICH is received to when a PUSCH is transmitted satisfies a smallest processing time of the UE and a transmission delay is relatively small.

A transmission delay is relatively small.

2. When an uplink-downlink subframe configuration is 1 and the current special subframe is a subframe n, determine that the PHICH resource is located in the K^{th} subframe after the current special subframe n, where

when n=1 or 6, K=4;

when n=1 or 6, K =5; or

when n=1 or 6, K=8.

Specifically, when the user equipment UE transmits the PUSCH in the special subframe 1 or 6, correspondingly, it is determined that the PHICH resource is located in the K^{th} subframe after a special subframe 1 or 6, where specific optional values of K may be shown in Table 3:

TABLE 3

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | D | D | S | U | U | D |
| configuration 1 | | | | | | | | | | |
| K1 = 4 | | 4 | | | | | 4 | | | |
| K2 = 5 | | 5 | | | | | 5 | | | |
| K3 = 8 | | 8 | | | | | 8 | | | |

In a specific subframe structure, for an UL/DL configuration 1 (uplink-downlink subframe configuration 1):

A. As shown in Table 3, in a case in which K1=4, for a PUSCH transmitted in a special subframe n=1, the UE receives corresponding HARQ downlink PHICH feedback information (that is, receives the PHICH on the determined PHICH resource) in the fourth subframe after the subframe n=1, that is, receives, in a subframe m=5, the HARQ downlink PHICH feedback information corresponding to the PUSCH; for a PUSCH transmitted in a subframe n=6, the UE receives, in a subframe m=0 in a next radio frame, the HARQ downlink PHICH feedback information corresponding to the PUSCH.

In the foregoing embodiment, it is determined that the PHICH resource is located in the fourth subframe after the current special subframe. Therefore, a case in which more than one

PHICH is received in one subframe is avoided, and a smallest change is made to the existing protocol, and meanwhile, a time interval from when a PUSCH is transmitted to when a PHICH is received better satisfies a requirement of a smallest processing time of the base station and a transmission delay is relatively small.

B. As shown in Table 3, in a case in which K2=5, for a PUSCH transmitted in a special subframe n=1, the UE receives corresponding HARQ downlink PHICH feedback information (that is, receives the PHICH on the determined PHICH resource) in the fifth subframe after the subframe n=1, that is, receives, in a subframe n=6, the HARQ downlink PHICH feedback information corresponding to the PUSCH; for a PUSCH transmitted in the subframe n=6, the UE receives, in a subframe n=1 in a next radio frame, the HARQ downlink PHICH feedback information corresponding to the PUSCH.

C. As shown in Table 3, in a case in which K3=8, for a PUSCH transmitted in a special subframe n=1, the UE receives corresponding HARQ downlink PHICH feedback information (that is, receives the PHICH on the determined PHICH resource) in the eighth subframe after the subframe n=1, that is, receives, in a subframe m=9, the HARQ downlink PHICH feedback information corresponding to the PUSCH; for a PUSCH transmitted in a subframe n=6, the UE receives, in a subframe m=4 in a next radio frame, the HARQ downlink PHICH feedback information corresponding to the PUSCH.

In the foregoing embodiment, it is determined that the PHICH resource is located in the eighth subframe after the current special subframe. Therefore, a case in which more than two PHICHs are received in one subframe is avoided, a smallest change is made to the existing protocol, and meanwhile, a time interval from when a PUSCH is transmitted to when a PHICH is received satisfies a requirement of a smallest processing time of the base station and a transmission delay is relatively small.

3. When an uplink-downlink subframe configuration is 2 and the current special subframe is a subframe n, determine that the PHICH resource is located in the K^{th} subframe after the current special subframe n, where

when n=1 or 6, K=4;

when n=1 or 6, K=5;

when n=1 or 6, K =7; or

when n=1 or 6, K=8.

Specifically, when the user equipment UE transmits the PUSCH in the special subframe 1 or 6, correspondingly, it is determined that the PHICH resource is located in the K^{th} subframe after the special subframe 1 or 6, where specific optional values of K may be shown in Table 4:

TABLE 4

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | D | D | D | S | U | D | D |
| configuration 2 | | | | | | | | | | |
| K1 = 4 | | 4 | | | | | 4 | | | |
| K2 = 5 | | 5 | | | | | 5 | | | |
| K3 = 7 | | 7 | | | | | 7 | | | |
| K4 = 8 | | 8 | | | | | 8 | | | |

In a specific subframe structure, for an UL/DL configuration 2 (uplink-downlink subframe configuration 2):

As shown in Table 4, in a case in which K1=4, for a PUSCH transmitted in a special subframe n=1, the UE receives corresponding HARQ downlink PHICH feedback information (that is, receives the PHICH on the determined PHICH resource) in the fourth subframe after the subframe 1, that is, receives, in a subframe m=5, the HARQ downlink PHICH feedback information corresponding to the PUSCH; for a PUSCH transmitted in a subframe n=6, the UE receives, in a subframe m=0 in a next radio frame, the HARQ downlink PHICH feedback information corresponding to the PUSCH.

In Table 4, in a case in which K2=5, K3=7, and K4=8, when the UE transmits a PUSCH in a special subframe n=1 or 6, the UE receives corresponding HARQ downlink PHICH feedback information in a specific subframe. With reference to the values of K in Table 4, a determining manner of the specific subframe is the same as that of K1=4, and details are not described herein again.

4. When an uplink-downlink subframe configuration is 3 and the current special subframe is a subframe n, determine that the PHICH resource is located in the K^{th} subframe after the current special subframe n, where when n=1, K=4, 5, 6, 7, 8, or 9.

Specifically, when the user equipment UE transmits the PUSCH in the special subframe n=1, correspondingly, it is determined that the PHICH resource is located in the K^{th} subframe after the special subframe 1, where specific optional values of K may be shown in Table 5:

TABLE 5

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | U | D | D | D | D | D |
| configuration 3 | | | | | | | | | | |
| K1 = 4 | | 4 | | | | | | | | |
| K2 = 5 | | 5 | | | | | | | | |
| K3 = 6 | | 6 | | | | | | | | |
| K4 = 7 | | 7 | | | | | | | | |
| K5 = 8 | | 8 | | | | | | | | |
| K6 = 9 | | 9 | | | | | | | | |

In a specific subframe structure, for an UL/DL configuration 3 (uplink-downlink subframe configuration 3):

As shown in Table 5, in a case in which K1=4, for a PUSCH transmitted in a special subframe n=1, the UE receives corresponding HARQ downlink PHICH feedback information (receives the PHICH on the determined PHICH resource) in the fourth subframe after the subframe 1, that is, receive, in a subframe m=5, the HARQ downlink PHICH feedback information corresponding to the PUSCH.

In Table 5, in a case in which K2=5, K3=6, K4=7, K5=8, and K6=9, when the UE transmits a PUSCH in a special subframe n=1, the UE receives corresponding HARQ downlink PHICH feedback information in a specific subframe. With reference to the values of K in Table 5, a determining manner of the specific subframe is the same as that of K1=4, and details are not described herein again.

5. When an uplink-downlink subframe configuration is 4 and the current special subframe is a subframe n, determine that the PHICH resource is located in the K^{th} subframe after the current special subframe n, where when n=1, K=4, 5, 6, 7, 8, or 9.

Specifically, when the user equipment UE transmits the PUSCH in the special subframe 1, correspondingly, it is determined that the PHICH resource is located in the K^{th} subframe after the special subframe 1, where specific optional values of K may be shown in Table 6:

TABLE 6

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | D | D | D | D | D | D |
| configuration 4 | | | | | | | | | | |
| K1 = 4 | | 4 | | | | | | | | |
| K2 = 5 | | 5 | | | | | | | | |
| K3 = 6 | | 6 | | | | | | | | |
| K4 = 7 | | 7 | | | | | | | | |
| K5 = 8 | | 8 | | | | | | | | |
| K6 = 9 | | 9 | | | | | | | | |

In a specific subframe structure, for an UL/DL configuration 4 (uplink-downlink subframe configuration 4):

As shown in Table 6, in a case in which K1=4, for a PUSCH transmitted in a special subframe n=1, the UE receives corresponding HARQ downlink PHICH feedback information (receives the PHICH on the determined PHICH resource) in the fourth subframe after the subframe 1, that is, receive, in a subframe m=5, the HARQ downlink PHICH feedback information corresponding to the PUSCH.

In Table 6, in a case in which K2=5, K3=6, K4=7, K5=8, and K6=9, when the UE transmits a PUSCH in a special subframe n=1, the UE receives corresponding HARQ downlink PHICH feedback information in a specific subframe. With reference to the values of K in Table 6, a determining manner of the specific subframe is the same as that of K1=4, and details are not described herein again.

6. When an uplink-downlink subframe configuration is 5 and the current special subframe is a subframe n, determine that the PHICH resource is located in the K^{th} subframe after the current special subframe n, where when n=1, K=4, 5, 6, 7, 8, or 9.

Specifically, when the user equipment UE transmits the PUSCH in the special subframe n=1, correspondingly, it is determined that the PHICH resource is located in the K^{th} subframe after the special subframe 1, where specific optional values of K may be shown in Table 7:

TABLE 7

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | D | D | D | D | D | D | D |
| configuration 5 | | | | | | | | | | |
| K1 = 4 | | 4 | | | | | | | | |
| K2 = 5 | | 5 | | | | | | | | |
| K3 = 6 | | 6 | | | | | | | | |
| K4 = 7 | | 7 | | | | | | | | |
| K5 = 8 | | 8 | | | | | | | | |
| K6 = 9 | | 9 | | | | | | | | |

In a specific subframe structure, for an UL/DL configuration 5 (uplink-downlink subframe configuration 5):

As shown in Table 7, in a case in which K1=4, for a PUSCH transmitted in a special subframe n=1, the UE receives corresponding HARQ downlink PHICH feedback information (receives the PHICH on the determined PHICH resource) in the fourth subframe after the subframe 1, that is, receive, in a subframe m=5, the HARQ downlink PHICH feedback information corresponding to the PUSCH.

In Table 7, in a case in which K2=5, K3=6, K4=7, K5=8, and K6=9, when the UE transmits a PUSCH in a special subframe n=1, the UE receives corresponding HARQ downlink PHICH feedback information in a specific subframe. A determining manner of the specific subframe is the same as that of K1=4, and details are not described herein again.

7. When an uplink-downlink subframe configuration is 6 and the current special subframe is a subframe n, determine that the PHICH resource is located in the K^{th} subframe after the current special subframe n, where

when n=1 or 6, K=4;

when n=1 or 6, K=5;

when n=1 or 6, K=8;

when n=1 or 6, K =9; or

when n=1 or 6, K=10.

Specifically, when the user equipment UE transmits the PUSCH in the special subframe 1, correspondingly, it is determined that the PHICH resource is located in the K^{th} subframe after the special subframe 1, where specific optional values of K may be shown in Table 8:

TABLE 8

| | Subframe | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | U | D | S | U | U | D |
| configuration 6 | | | | | | | | | | |
| K1 = 4 | | 4 | | | | | 4 | | | |
| K2 = 5 | | 5 | | | | | 5 | | | |
| K3 = 8 | | 8 | | | | | 8 | | | |
| K4 = 9 | | 9 | | | | | 9 | | | |
| K5 = 10 | | 10 | | | | | 10 | | | |

In a specific subframe structure, for an UL/DL configuration 6 (uplink-downlink subframe configuration 6):

As shown in Table 8, in a case in which K1=4, for a PUSCH transmitted in a special subframe n=1, the UE receives corresponding HARQ downlink PHICH feedback information (that is, receives the PHICH on the determined PHICH resource) in the fourth subframe after the subframe n=1, that is, receives, in a subframe m=5, the HARQ downlink PHICH feedback information corresponding to the PUSCH; for a PUSCH transmitted in a subframe n=6, the UE receives, in a subframe m=0 in a next radio frame, the HARQ downlink PHICH feedback information corresponding to the PUSCH.

In Table 8, in a case in which K2=5, K3=8, K4=9, and K5=10, when the UE transmits a PUSCH in a special subframe n=1 or 6, the UE receives corresponding HARQ downlink PHICH feedback information in a specific subframe. A determining manner of the specific subframe is the same as the of K1=4, and details are not described herein again.

In the foregoing embodiment, each configuration corresponds to multiple values of K for a reason the same as that of selecting the value of K for the configuration 0. The values of K selected for each configuration also have a beneficial effect the same as that of the values of K selected for the configuration 0, and details are not described herein.

In a case in which each of Table 2 to Table 8 provides one subframe configuration, there are multiple optional values of K. In a specific application environment, optional values of K in each table may be combined with values of K in another table to form seven uplink-downlink subframe configurations defined in the Long Term Evolution (LTE, Long Term Evolution) TDD system, where one uplink-downlink subframe configuration may be a combination shown in Table 9:

TABLE 9

| Subframe | Subframe | | | | | | | | | |
|---|---|---|---|---|---|---|---|---|---|---|
| configuration | 0 | 1 | 2 | 3 | 4 | 5 | 6 | 7 | 8 | 9 |
| 0 | | K = 5 | 4 | 7 | 6 | | K = 5 | 4 | 7 | 6 |
| 1 | | 4 | 4 | 6 | | | 4 | 4 | 6 | |
| 2 | | 5 | 6 | | | | 5 | 6 | | |
| 3 | | 6 | 6 | 6 | 6 | | | | | |
| 4 | | 6 | 6 | 6 | | | | | | |
| 5 | | 6 | 6 | | | | | | | |
| 6 | | 5 | 4 | 6 | 6 | | 5 | 4 | 7 | |

In an instance shown in Table 9, when the current special subframe is a subframe n, it is determined that the PHICH resource is located in the K^{th} subframe after the current special subframe n, where in a configuration 0, n=1 or 6, and K=5; in a configuration 1, n=1 or 6, and K =4; in a configuration 2, n=1 or 6, and K=5; in a configuration 3, n=1 and K=6; in a configuration 4, n=1 and K=6; in a configuration 5, n=1 and K=6; and in a configuration 6, n =1 or 6 and K =5.

II. When a subframe of the uplink resource used to transmit the PUSCH includes the current special subframe and another subframe, the determining, by the UE according to the uplink resource used to transmit the PUSCH, a subframe position of the PHICH resource corresponding to the PUSCH includes:

Further, the existing protocol Rel-11 further specifies: an uplink PUSCH may be transmitted in a subframe bundling (subframe bundling or TTI bundling) manner. A manner of bundling a UpPTS and another uplink resource is used to transmit the PUSCH, which is equivalent to increasing a quantity of times of transmitting the uplink data within unit time, thereby increasing a signal to noise ratio of uplink data receiving, and further increasing uplink coverage. In this embodiment of the present invention, when the subframe of the uplink resource used to transmit the PUSCH includes the current special subframe and a coordination subframe bundled with the current special subframe, the determining, by the UE according to the uplink resource used to transmit the PUSCH, a subframe position of the PHICH resource corresponding to the PUSCH includes:

determining, according to the coordination subframe, the subframe position of the PHICH resource corresponding to the PUSCH.

In this embodiment of the present invention, the coordination subframe refers to: when the special subframe used to transmit the PUSCH is bundled with another subframe, another subframe in the bundle subframe except the special subframe used to transmit the PUSCH.

The coordination subframe includes at least one uplink subframe in a radio frame of the current special subframe and/or another special subframe in the radio frame except the current special subframe.

Further, to comprehensively consider the transmission delay and the eNB processing time, and consider the transmission delay and the UE processing time, a current RTT value (that is, a time from when a data packet is transmitted for the first time to when the data packet is retransmitted) is reused as far as possible or an additional RTT value as smaller as possible is added. Therefore, in this embodiment of the present invention, the determining, by the UE according to the uplink resource used to transmit the PUSCH, a subframe position of the PHICH resource corresponding to the PUSCH includes:

determining, according to the last subframe L in the coordination subframe, the subframe position of the PHICH resource corresponding to the PUSCH.

Specifically, with reference to the seven uplink-downlink subframe configurations that are defined in the LTE TDD system and that are shown in Table 1, the following describes in detail an implementable solution of determining, in each configuration according to the last subframe L in the coordination subframe, the subframe position of the PHICH resource corresponding to the PUSCH:

Because for different configurations, positions and quantities of uplink subframes are different, during specific bundling, there may be multiple cases. The following gives a description according to different bundling cases.

Manner 1: All uplink subframes and special subframes in one radio frame are bundled to form one bundle subframe, and one bundle subframe corresponds to one HARQ process. Specific implementation may be:

1. If an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, where L=9 and K=6.

Specifically, when the user equipment UE transmits the PUSCH in the special subframe 1 or 6, correspondingly, it is determined that the PHICH resource is located in the K^{th} subframe after the last subframe L of the bundle subframe, where specific optional values of K may be shown in Table 10:

TABLE 10

| | Subframe number | | | | | | | | | |
|---|---|---|---|---|---|---|---|---|---|---|
| | 0 | 1 | 2 | 3 | 4 | 5 | 6 | 7 | 8 | 9 |
| Subframe | D | S | U | U | U | D | S | U | U | U |
| configuration 0 | | | | | | | | | | |
| | | | | | | | | | | 6 |

In Table 10, subframes 1, 2, 3, 4, 6, 7, 8, and 9 marked with slashes are bundled to transmit data.

As shown in Table 10, the uplink-downlink subframe configuration is 0, when special subframes 1 and 6 in one radio frame are bundled with subframes 2, 3, 4, 7, 8, and 9 in the radio frame, for a PUSCH transmitted in the special subframe 1, the UE receives corresponding HARQ downlink PHICH feedback information in the sixth subframe after the subframe 9, that is, receives, in a subframe 5 in a next radio frame, the HARQ downlink PHICH feedback information corresponding to the PUSCH.

In this embodiment, when the special subframes 1 and 6 are bundled with the subframes 2, 3, 4, 7, 8, and 9 in the radio frame, the bundled subframes may be considered as an entirety; therefore, a subframe position, used to receive the PHICH, in the original subframe 9 may be reused as the PUSCH sent by using the special subframe. In this case, a smallest change may be made to the protocol. A time interval from when the PUSCH is transmitted to when the PHICH is received is a smallest value when the processing time (3 ms) of the base station is the smallest, which effectively reduces the transmission delay. In addition, the bundling manner may implement PUSCH transmission of three HARQ processes and/or of an RTT being 30 ms. For a delay-sensitive service such as VOIP (Voice over Internet Protocol, Voice over Internet Protocol), a transmission delay generally needs to be about 50 ms, and an RTT value of an HARQ process is set to 30 ms, which can increase a time diversity gain for transmission of the delay-sensitive service. Quantities of UpPTSs included in the HARQ processes are the same, which reduces the complexity that the system (UE or base station) coordinates processing the HARQ processes.

2. If an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, where L=8 and K=6.

In this embodiment, when the special subframe 1 and 6 are bundled with the subframes 2, 3, 7, and 8 in the radio frame, the bundled subframes may be considered as an entirety; therefore, the subframe position, used to receive the PHICH, in the original subframe 8 may be reused for the PUSCH sent by using the special subframe. A time interval from when the PUSCH is transmitted to when the PHICH is received is a smallest value when processing time (3 ms) of the base station is the smallest, which effectively reduces the transmission delay. In addition, this bundling manner may implement PUSCH transmission, of two HARQ processes, having an RTT being 20 ms or PUSCH transmission, of three HARQ processes, having an RTT being 30 ms. For a delay-sensitive service such as VOIP, a transmission delay generally needs to be about 50 ms, and an RTT value of the HARQ process is set to 20 ms or 30 ms, which can effectively increase a time diversity gain for transmission of the delay-sensitive service. In addition, quantities of UpPTSs included in the HARQ processes are the same, which reduces the complexity that the system (UE or base station) coordinates processing the HARQ processes.

3. If an uplink-downlink subframe configuration is 2, when special subframes 1 and 6 in a radio frame are bundled with subframes 2 and 7 in the radio frame, determine that the PHICH resource is located in the K^{th} subframe after the last subframe L, where L=7 and K=6, 9, or 19.

In this embodiment, it is determined that the PHICH resource is located in the sixth subframe after the current special subframe, and a time interval from when the PUSCH is transmitted to when the PHICH is received is a smallest value when processing time (3 ms) of the base station is the smallest, which effectively reduces the transmission delay.

For PUSCH transmission whose RTT is 20 ms when K=6 or 9 or PUSCH transmission whose RTT is 30 ms when K 19, for a delay-sensitive service such as VOIP, a transmission delay generally needs to be about 50 ms, and an RTT value of the HARQ process is set to 20 ms or 30 ms, which can effectively increase a time diversity gain for transmission of the delay-sensitive service. In addition, quantities of UpPTSs included in the HARQ processes are the same, which reduces the complexity that the system (UE or base station) coordinates processing the HARQ processes.

4. If an uplink-downlink subframe configuration is 3, when a special subframe 1 in a radio frame is bundled with subframes 2, 3, and 4 in the radio frame, determine that the PHICH resource is located in the K^{th} subframe after the last subframe L, where L=4 and K=16.

5. If an uplink-downlink subframe configuration is 4, when a special subframe 1 in a radio frame is bundled with subframes 2 and 3 in the radio frame, determine that the PHICH resource is located in the K^{th} subframe after the last subframe L, where L=4 and K=6.

6. If an uplink-downlink subframe configuration is 5, when a special subframe 1 in a radio frame is bundled with a subframe 2 in the radio frame, determine that the PHICH resource is located in the K^{th} subframe after the subframe 2, where K=5, 15, or 25.

7. If an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, where L=8 and K=17.

Manner 2: When one radio frame includes two special subframes, each special subframe may form one bundle subframe, and bundle subframes separately correspond to different HARQ processes, specific implementation may be:

1. If an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the determining, according to the last subframe L in the coordination subframe, the subframe position of the PHICH resource corresponding to the PUSCH includes:

a first PHICH resource corresponding to the first bundle frame is located in the K1^{th} subframe after the last subframe L, where L=2 and K1=4; and

a second PHICH resource corresponding to the second bundle frame is located in the K2^{th} subframe after the last subframe L, where L=7 and K2=4.

Specifically, when the user equipment UE transmits the PUSCH in the special subframe 1 or 6, correspondingly, it is determined that the PHICH resource is located in the K^{th} subframe after the last subframe L of the bundle subframe, where specific optional values of K may be shown in Table 11:

TABLE 11

| Subframe | Subframe number | | | | | | | | | |
|---|---|---|---|---|---|---|---|---|---|---|
| configuration | 0 | 1 | 2 | 3 | 4 | 5 | 6 | 7 | 8 | 9 |
| | D | S | U | D | D | D | S | U | D | D |
| 2 | | | 4 | | | | | 4 | | |

In Table 11, subframes 1 and 2 marked by horizontal lines are bundled to form a first bundle frame, and subframes 6 and 7 marked with vertical lines are bundled to form a second bundle frame.

As shown in Table 11, the uplink-downlink subframe configuration is 2, when a special subframe 1 in a radio frame and a subframe 2 in the radio frame are bundled to form a first bundle frame, for a PUSCH transmitted in the special subframe 1, the UE receives corresponding HARQ downlink PHICH feedback information in the fourth subframe after the subframe 2, that is, receives, in a subframe 6 in the radio frame, the HARQ downlink PHICH feedback information corresponding to the PUSCH transmitted in the special subframe 1; and when a special subframe n=6 in a radio frame and a subframe m=7 in the radio frame are bundled to form a second bundle frame, for a PUSCH transmitted in the special subframe n=6, the UE receives corresponding HARQ downlink PHICH feedback information in the fourth subframe after the subframe 7, that is, receives, in a subframe 1 in a next radio frame, the HARQ downlink PHICH feedback information corresponding to the PUSCH transmitted in the special subframe 6.

2. If an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the determining, according to the last subframe L in the coordination subframe, the subframe position of the PHICH resource corresponding to the PUSCH includes:

a first PHICH resource corresponding to the first bundle frame is located in the K^{th} subframe after the last subframe L, where L=3 and K=6;

a second PHICH resource corresponding to the second bundle frame is located in the K^{th} subframe after the last subframe L, where L=2 and K=6; and

a third PHICH resource corresponding to the third bundle frame is located in the K^{th} subframe after the last subframe L, where L=4 and K=6.

In this embodiment, when a special subframe is bundled with another subframe in the radio frame, the bundled subframes may be considered as an entirety; therefore, the subframe position, used to receive the PHICH, in the original subframe 8 may be reused for the PUSCH sent by using the special subframe. A time interval from when the PUSCH is transmitted to when the PHICH is received is a smallest value when processing time (3 ms) of the base station is the smallest, which effectively reduces the transmission delay.

After the UE determines the subframe position of the PHICH resource corresponding to the PUSCH, PHICH information corresponding to the PUSCH may be determined uniquely by using the following formula according to the PHICH group number and an orthogonal sequence number (n_{PHICH}^{group}, n_{PHICH}^{seq}) of the PHICH in the group and is separated:

n_{PHICH}^{group}=(I_{PRB}_{_}_{RA}+n_{DMRS})mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS})mod 2N_{SF}^{PHICH}

where n_{DMRS} is a demodulation reference signal cyclic shift value, I_{PRB}_{_}_{RA} is a lowest index (lowest index) of a resource block, N_{SF}^{PHICH} is a length of a PHICH spreading factor, and N_{PHICH}^{group} is a PHICH group quantity.

In the method provided in this embodiment of the present invention, a time frequency domain of the PHICH resource is further determined. In the method, the PHICH group number of the PHICH resource is further determined according to the subframe position, which specifically includes:

determining, according to the subframe position corresponding to the PHICH resource and by using a PHICH group number indication factor I_{PHICH}, the PHICH group number corresponding to the PUSCH.

In a specific instance, the determining the PHICH group number of the PHICH resource according to the subframe position includes:

A. Determining of the I_{PHICH} in this embodiment of the present invention is further described in detail by using an instance shown in Table 12.

TABLE 12

| Subframe | Subframe number | | | | | | | | | |
|---|---|---|---|---|---|---|---|---|---|---|
| configuration | 0 | 1 | 2 | 3 | 4 | 5 | 6 | 7 | 8 | 9 |
| 0 | | 5 | 4 | 7 | 6 | | 5 | 4 | 7 | 6 |

As can be known from Table 12, for a UL/DL configuration 0, the special subframe 1 or 6 is used to transmit a PUSCH, and a PHICH resource corresponding to the PUSCH is located in the fifth subframe after the special subframe; then, in this case:

In the configuration UL/DL configuration 0, an example of a case in which a same subframe corresponds to PHICH resources of different PUSCHs is:

a. For PUSCHs transmitted in a special subframe 1 and an uplink subframe 2, corresponding PHICHs are received in a subframe 6.

To distinguish PHICH resources, corresponding to different PUSCHs, in a same subframe, it is specified that a PHICH group number indication factor of the PHICH resource corresponding to the PUSCH transmitted in the subframe 1 or 2 is I_{PHICH}=1.

a. For PUSCHs transmitted in a special subframe 6 and an uplink subframe 7, corresponding PHICHs are received in a subframe 1.

To distinguish PHICH resources, corresponding to different PUSCHs, in a same subframe, it is specified that a PHICH group number indication factor of the PHICH resource corresponding to the PUSCH transmitted in the subframe 6 or 7 is zI_{PHICH}=1.

Based on the foregoing case, it may be specified that PHICH group number indication factors of the PHICH resources corresponding to the PUSCHs transmitted in the subframes 2 and 7 are I_{PHICH}=1; or it may be specified that PHICH group number indication factors of the PHICH resources corresponding to the PUSCHs transmitted in the subframes 1 and 6 are I_{PHICH}=1. In addition, in the configuration, downlink PHICHs corresponding to the subframes 3 and 4 are transmitted in a same subframe, and downlink PHICHs corresponding to the subframes 8 and 9 are transmitted in a same subframe.

In the configuration, for the four groups of subframes {1, 2}, {3, 4}, {6, 7}, and {8, 9}, the downlink PHICHs are received in a same subframe. To distinguish PHICH resources, corresponding to different PUSCHs, in a same subframe, in the method provided in this embodiment of the present invention, I_{PHICH =1}of the PHICH resource corresponding to one subframe is selected from each group of subframes, and there are two options for each group of subframes. Under the premise that the foregoing case exists in four groups of subframes in the configuration, there are 16 implementation manners for forming I_{PHICH} in the configuration. In addition, a value of I_{PHICH} corresponding to an original subframe is reused as far as possible or a value of I_{PHICH} corresponding to an original subframe is changed as less as possible. Values of I_{PHICH} are selected according to the foregoing rule. To simplify the description, two manners of forming a value of I_{PHICH} are specifically described below.

Manner 1: Based on the foregoing case, in implementation of the present invention, when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determine, by using the determined I_{PHICH} , the PHICH group number corresponding to the PUSCH.

In an actual application environment, the foregoing implementation manner 1 may further be expressed by using a specific formula. The specific formula may be:

$${I}_{PHICH} = \{ \begin{matrix}1 & for TDD UL \text{/} DL configuration 0 with PUSCH transmission \\ & in subframe m = 2 , 4 , 7 or 9 \\ 0 & otherwise\end{matrix}$$

Manner 2: When an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determine, by using the determined I_{PHICH,} the PHICH group number corresponding to the PUSCH.

In an actual application environment, the foregoing implementation manner 2 may further be expressed by using a specific formula. The specific formula may be:

$${I}_{PHICH} = \{ \begin{matrix}1 & for TDD UL \text{/} DL configuration 0 with PUSCH transmission \\ & in subframe m = 1 , 4 , 6 or 9 \\ 0 & otherwise\end{matrix}$$

In addition, for a UL/DL configuration 6, the special subframe 1 or 6 is used to transmit a PUSCH, and a PHICH resource corresponding to the PUSCH is located in the fourth subframe after the special subframe; then, in this case:

a. For a PUSCH transmitted in a special subframe 1 and a PUSCH transmitted in an uplink subframe 8 in a previous radio frame, corresponding downlink PHICHs are received in a subframe 5.

To distinguish PHICH resources, corresponding to different PUSCHs, in a same subframe, it is specified that a PHICH group number indication factor of the PHICH resource corresponding to the PUSCH transmitted in the subframe 1 or corresponding to the PUSCH transmitted in the subframe 8 in the previous radio frame is I_{PHICH}=1

b. For PUSCHs transmitted in an uplink subframe 4 and a special subframe 6, corresponding PHICHs are received in a subframe 0 in a next radio frame.

To distinguish PHICH resources, corresponding to different PUSCHs, in a subframe 0, it is specified that a PHICH group number indication factor of the PHICH resource corresponding to the PUSCH transmitted in the subframe 4 or 6 is I_{PHICH}=1.

Based on the foregoing case, it may be specified that PHICH group number indication factors of the PHICH resources corresponding to the PUSCHs transmitted in the subframes 6 and 8 are I_{PHICH}=1; or it may be specified that PHICH group number indication factors of the PHICH resources corresponding to the PUSCHs transmitted in the subframes 1 and 4 are I_{PHICH}=1.

Based on the foregoing case, in the implementation of the present invention, when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 6 and 8 are 1, and I_{PHICH} corresponding to another subframe in the radio frame of the current special subframe except the subframes 6 and 8 is 0, and determine, by using the determined I_{PHICH}, the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 1 and 4 are 1, and I_{PHICH} corresponding to another subframe in the radio frame of the current special subframe except the subframes 1 and 4 is 0, and determine, by using the determined I_{PHICH} , the PHICH group number corresponding to the PUSCH.

### Embodiment 2

In this embodiment of the present invention, considering that in one RTT period, timing from an uplink PUSCH to a downlink PHICH is not less than 4 ms, and in HARQ retransmission, a time from when UE receives a PHICH to when the UE sends a PUSCH is not less than 4 ms, the following provides an instance in which an RTT is 10 ms.

When the user equipment UE transmits a PUSCH in a special subframe, correspondingly, it is determined that the PHICH resource is located in the K^{th} subframe after the special subframe, where in each configuration, specific optional values of K may be shown in Table 13:

TABLE 13

| Subframe | Subframe | | | | | | | | | |
|---|---|---|---|---|---|---|---|---|---|---|
| configuration | 0 | 1 | 2 | 3 | 4 | 5 | 6 | 7 | 8 | 9 |
| 0 | | 5 | 4 | 7 | 6 | | 5 | 4 | 7 | 6 |
| 1 | | 4 | 4 | 6 | | | 4 | 4 | 6 | |
| 2 | | 5 | 6 | | | | 5 | 6 | | |
| 3 | | 6 | 6 | 6 | 6 | | | | | |
| 4 | | 6 | 6 | 6 | | | | | | |
| 5 | | 6 | 6 | | | | | | | |
| 6 | | 5 | 4 | 6 | 6 | | 5 | 4 | 7 | |

In this embodiment, according to a specific instance given in Table 13, the current special subframe is a subframe n, and specific implementation of determining that the PHICH resource is located in the K^{th} subframe after the current special subframe n includes:

<1>. For a DL/UL configuration 0, for a PUSCH transmitted in a special subframe n=1, the UE receives corresponding HARQ downlink PHICH feedback information in the fifth subframe after the subframe 1, that is, receives, in a special subframe n=6, the HARQ downlink PHICH feedback information corresponding to the PUSCH; for a PUSCH transmitted in the special subframe n=6, the UE receives corresponding HARQ downlink PHICH feedback information (that is, the UE receives, in a special subframe n=1 in a next radio frame, the HARQ downlink PHICH feedback information corresponding to the PUSCH) in the fifth subframe after the subframe 6.

<2>. For a DL/UL configuration 1, for a PUSCH transmitted in a special subframe n=1, the UE receives corresponding HARQ downlink PHICH feedback information in the fourth subframe after the subframe 1 (receives the PHICH on the determined PHICH resource), that is, receives, in a special subframe m=5, the HARQ downlink PHICH feedback information corresponding to the PUSCH; for a PUSCH transmitted in a special subframe n=6, the UE receives corresponding HARQ downlink PHICH feedback information in the fourth subframe after the subframe 6, that is, the UE receives, in a special subframe m=0 in a next radio frame, the HARQ downlink PHICH feedback information corresponding to the PUSCH.

<1>. For a DL/UL configuration 2, for a PUSCH transmitted in a special subframe n=1, the UE receives corresponding HARQ downlink PHICH feedback information in the fifth subframe after the subframe 1 (receives the PHICH on the determined PHICH resource), that is, receives, in a special subframe 6, the HARQ downlink PHICH feedback information corresponding to the PUSCH; for a PUSCH transmitted in the special subframe n=6, the UE receives corresponding

HARQ downlink PHICH feedback information in the fifth subframe after the subframe 6, that is, the UE receives, in a special subframe 1 in a next radio frame, the HARQ downlink PHICH feedback information corresponding to the PUSCH.

<1>. For a UL/DL configuration 3, for a PUSCH transmitted in a special subframe n=1, the UE receives corresponding HARQ downlink PHICH feedback information (receives the PHICH on the determined PHICH resource) in the sixth subframe after the subframe 1, that is, the UE receives, in a subframe 7, the HARQ downlink PHICH feedback information corresponding to the PUSCH.

<1>. For a UL/DL configuration 4, for a PUSCH transmitted in a special subframe n=1, the UE receives corresponding HARQ downlink PHICH feedback information (receives the PHICH on the determined PHICH resource) in the sixth subframe after the subframe 1, that is, receives, in a subframe 7, the HARQ downlink PHICH feedback information corresponding to the PUSCH.

<1>. For a UL/DL configuration 5, for a PUSCH transmitted in a special subframe n=1, the UE receives corresponding HARQ downlink PHICH feedback information (receives the PHICH on the determined PHICH resource) in the sixth subframe after the subframe 1, that is, receives, in a subframe 7, the HARQ downlink PHICH feedback information corresponding to the PUSCH.

<1>. For a DL/UL configuration 6, for a PUSCH transmitted in a special subframe n=1, the UE receives corresponding HARQ downlink PHICH feedback information in the fifth subframe after the subframe 1, that is, receives, in a subframe n=6, the HARQ downlink PHICH feedback information corresponding to the PUSCH; for a PUSCH transmitted in the special subframe n=6, the UE receives corresponding HARQ downlink PHICH feedback information (that is, the UE receives, in a special subframe n=1 in a next radio frame, the HARQ downlink PHICH feedback information corresponding to the PUSCH) in the fifth subframe after the subframe 6.

By means of the method in this embodiment of the present invention, after the subframe position of the PHICH resource corresponding to the PUSCH is determined, a time frequency domain of the PHICH resource is further determined. Then, in this method, the determining, by using I_{PHICH} according to the subframe position corresponding to the PHICH resource, the PHICH group number corresponding to the PUSCH may be:

For a subframe configuration 0, downlink PHICHs corresponding to four pairs of subframes are transmitted in a same subframe, where the four pairs of subframes are respectively: 1 and 2, 3 and 4, 6 and 7, and 8 and 9; therefore, in this embodiment, a PHICH group number indication factor of a PHICH resource corresponding to a PUSCH transmitted in either subframe in each pair of subframes may be I_{PHICH}=1. In this instance, it may be specified that I_{PHICH} corresponding to the subframe m=2, 4, 7, and 9 is 1, and I_{PHICH} corresponding to another subframe in a radio frame of the current special subframe except the subframe m=2, 4, 7, and 9 is 0.

For a subframe configuration 6, downlink PHICHs corresponding to two pairs of subframes are transmitted in a same subframe, where the two pairs of subframes are respectively 1 and 8, and 4 and 6. Therefore, in this embodiment, a PHICH group number indication factor of a PHICH resource corresponding to a PUSCH transmitted in either subframe in each pair of subframes may be I_{PHICH}=1. In this instance, it may be specified that PHICH group number indication factors I_{PHICH} corresponding to the subframes 1 and 6 is 1, and I_{PHICH} corresponding to another subframe in the radio frame of the current special subframe except the subframes 1 and 6 is 0. The formula of the value of I_{PHICH} maybe:

$${I}_{PHICH} = \{ \begin{matrix}1 & for TDD UL \text{/} DL configuration 0 with PUSCH transmission \\ & in subframe m = 2 , 4 , 7 or 9 , \\ & and for TDD UL \text{/} DL configuration 6 \\ & with PUSCH transmission in subframe n = 1 or 6 \\ 0 & otherwise\end{matrix}$$

Correspondingly, the present invention specifies a value of mᵢ (representing a group quantity range factor of the PHICH) for the PHICH group quantity mᵢ·N_{PHICH}^{group}:

for a UL/DL configuration 0, because a PHICH resource is added in subframes 1 and 6, mᵢ=2;

for a UL/DL configuration 6, because a PHICH resource is added in subframes 1 and 6, mᵢ=2;

for a UL/DL configuration 1, because a PHICH resource is added in subframes 0 and 5, mᵢ=1;

for a UL/DL configuration 2, because a PHICH resource is added in subframes 1 and 6, mᵢ=1; and

similarly, for UL/DL configurations 3 to 5, because a PHICH resource is added in a subframe 7, mᵢ=1.

The PHICH resources in other subframes are unchanged, and in this embodiment, values of mᵢ in each configuration may be shown in Table 14.

TABLE 14

| Uplink-downlink | Subframe | | | | | | | | | |
|---|---|---|---|---|---|---|---|---|---|---|
| configuration | 0 | 1 | 2 | 3 | 4 | 5 | 6 | 7 | 8 | 9 |
| 0 | mᵢ = 2 | mᵢ = 2 | — | — | — | mᵢ = 2 | mᵢ = 2 | — | — | — |
| 1 | 1 | 1 | — | — | 1 | 1 | 1 | — | — | 1 |
| 2 | 0 | 1 | — | 1 | 0 | 0 | 1 | — | 1 | 0 |
| 3 | 1 | 0 | — | — | — | 0 | 0 | 1 | 1 | 1 |
| 4 | 0 | 0 | — | — | 0 | 0 | 0 | 1 | 1 | 1 |
| 5 | 0 | 0 | — | 0 | 0 | 0 | 0 | 1 | 1 | 0 |
| 6 | 1 | 2 | — | — | — | 1 | 2 | — | — | 1 |

### Embodiment 3

When a subframe of an uplink resource used to transmit a PUSCH includes a current special subframe and another subframe, that is, a special subframe and another normal subframe are bundled for transmission, in this embodiment, a timing relationship of each configuration when RTT=30 ms may be specifically:

for a UL/DL configuration 0, if special subframes 1 and 6 and normal subframes 2, 3, 4, 7, 8, and 9 are bundled as a bundle subframe (bundle) to transmit a PUSCH, a receiving position of a downlink PHICH corresponding to the bundle subframe is associated with the last subframe 9 in the bundle, k_{PHICH}=6, and a receiving position is a subframe 5 in a next radio frame;

for a UL/DL configuration 1, if special subframes 1 and 6 and normal subframes 2, 3, 7, and 8 are bundled as a bundle subframe (bundle) to transmit a PUSCH, a receiving position of a downlink PHICH corresponding to the bundle subframe is associated with the last subframe 8 in the bundle, k_{PHICH}=6, and a receiving position is a subframe 4 in a next radio frame;

for a UL/DL configuration 2, if special subframes 1 and 6 and normal subframes 2 and 7 are bundled as a bundle subframe (bundle) to transmit a PUSCH, a receiving position of a downlink PHICH corresponding to the bundle subframe is associated with the last subframe 7 in the bundle, k_{PHICH}=19, and a receiving position is a subframe 6 in the second radio frame after the frame;

for a UL/DL configuration 3, a special subframe 1 and normal subframes 2, 3, and 4 are bundled as a bundle subframe (bundle) to transmit a PUSCH, a receiving position of a downlink PHICH corresponding to the bundle subframe is associated with the last subframe 4 in the bundle, k_{PHICH}=16, and a receiving position is a subframe 0 in the second radio frame after the frame;

for a UL/DL configuration 4, a special subframe 1 and normal subframes 2 and 3 are bundled as a bundle subframe (bundle) to transmit a PUSCH, a receiving position of a downlink PHICH corresponding to the bundle subframe is associated with the last subframe 3 in the bundle, k_{PHICH}=6, and a receiving position is a subframe 9;

for a UL/DL configuration 5, a special subframe 1 and a normal subframe 2 are bundled as a bundle subframe (bundle) to transmit a PUSCH; then, a receiving position of a downlink PHICH corresponding to the bundle subframe is associated with the last subframe 2 in the bundle, k_{PHICH}=25, and a receiving position is a subframe 7 in the second radio frame after the frame; and

for a UL/DL configuration 6, special subframes 1 and 6 and normal subframes 2, 3, 4, 7, and 8 are bundled as a bundle subframe (bundle) to transmit a PUSCH, a receiving position of a downlink PHICH corresponding to the bundle subframe is associated with the last subframe 8 in the bundle, k_{PHICH}=17, and a receiving position is a subframe 5 in the second radio frame after the frame.

Specific optional values of the K determined according to the foregoing method may be shown in Table 15:

TABLE 15

| | Subframe | | | | | | | | | |
|---|---|---|---|---|---|---|---|---|---|---|
| Subframe configuration | 0 | 1 | 2 | 3 | 4 | 5 | 6 | 7 | 8 | 9 |
| 0 | | | | | | | | | | 6 |
| 1 | | | | | | | | | 6 | |
| 2 | | | | | | | | 19 | | |
| 3 | | | | | 16 | | | | | |
| 4 | | | | 6 | | | | | | |
| 5 | | | 25 | | | | | | | |
| 6 | | | | | | | | | 17 | |

### Embodiment 4

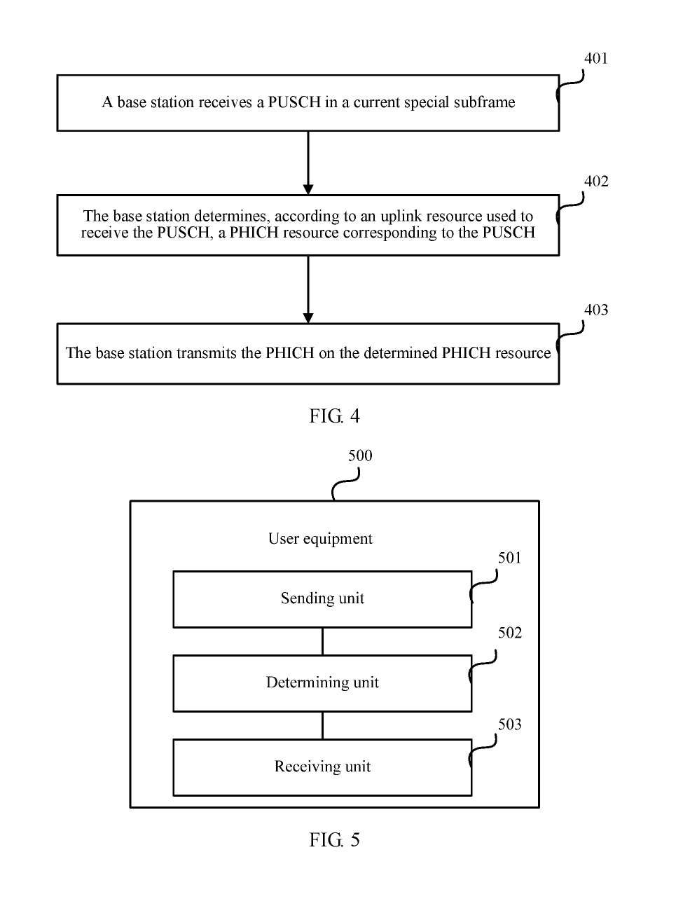

After user equipment transmits uplink data in a special subframe, a base station side needs to determine feedback information corresponding to the uplink data transmitted in a particular subframe; therefore, based on this idea, this embodiment of the present invention further provides another control channel resource allocation method. The method includes (a process of the method is shown in FIG. 4):

Step 401: A base station receives a PUSCH in a current special subframe.

Step 402: The base station determines, according to an uplink resource used to receive the PUSCH, a PHICH resource corresponding to the PUSCH, where the uplink resource used to transmit the PUSCH includes the current special subframe.

In this embodiment of the present invention, the determining, by the base station according to an uplink resource used to receive the PUSCH, a PHICH resource corresponding to the PUSCH includes:

determining, by the base station according to the uplink resource used to receive the PUSCH, a subframe position of the PHICH resource corresponding to the PUSCH; and

determining a PHICH group number of the PHICH resource according to the subframe position, and determining, according to the subframe position and the PHICH group number, the PHICH resource corresponding to the PUSCH.

Step 403: The base station transmits a PHICH on the determined PHICH resource.

According to the foregoing method, the following describes in detail the method provided in this embodiment of the present invention with reference to tables and various uplink-downlink subframe configurations.

I. When a subframe of the uplink resource used to transmit the PUSCH is only the current special subframe, the determining, by the base station according to the uplink resource used to receive the PUSCH, a subframe position of the PHICH resource corresponding to the PUSCH includes:

specifically, with reference to seven uplink-downlink subframe configurations that are defined in the LTE (LTE, Long Term Evolution) TDD system and that are shown in Table 1, the following describes in detail an implementable solution of the PHICH resource in each configuration:

when an uplink-downlink subframe configuration is 0 and the current special subframe is a subframe n, determining that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determining that the PHICH resource is located in the K^{th} subframe after the current special subframe n, where

when n=1 or 6, K=4;

when n=1 or 6, K=5; or

when n=1 or 6, K=8; or

when an uplink-downlink subframe configuration is 2 and the current special subframe is a subframe n, determining that the PHICH resource is located in the K^{th} subframe after the current special subframe n, where

when n=1 or 6, K=4;

when n=1 or 6, K=5;

when n=1 or 6, K=7; or

when n=1 or 6, K=8; or

when an uplink-downlink subframe configuration is 3 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determining that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determining that the PHICH resource is located in the K^{th} subframe after the current special subframe n, where

when n=1 or 6, K=4; when n 1 or 6, K=5; when n=1 or 6, K =8; when n=1 or 6, K=9; or when n=1 or 6, K=10.

II. The existing protocol Rel-11 further specifies: an uplink PUSCH may be transmitted in a subframe bundling (subframe bundling or TTI bundling) manner. When a subframe of the uplink resource used to transmit the PUSCH includes the current special subframe and another subframe, the determining, by the base station according to the uplink resource used to receive the PUSCH, a subframe position of the PHICH resource corresponding to the PUSCH includes:

when a subframe of the uplink resource used to transmit the PUSCH includes the current special subframe and a coordination subframe bundled with the current special subframe, the determining, by the base station according to the uplink resource used to receive the PUSCH, a subframe position of the PHICH resource corresponding to the PUSCH includes:

determining, according to the coordination subframe, the subframe position of the PHICH resource corresponding to the PUSCH.

In this embodiment of the present invention, the coordination subframe includes at least one uplink subframe in a radio frame of the current special subframe and/or another special subframe in the radio frame except the current special subframe.

Further, to comprehensively consider a transmission delay and eNB processing time, and consider a transmission delay and UE processing time, in this embodiment of the present invention, the determining, by the base station according to the uplink resource used to receive the PUSCH, a subframe position of the PHICH resource corresponding to the PUSCH includes:

determining, according to the last subframe L in the coordination subframe, the subframe position of the PHICH resource corresponding to the PUSCH.

Specifically, with reference to the seven uplink-downlink subframe configurations that are defined in the LTE TDD system and that are shown in Table 1, the following describes in detail an implementable solution of determining, in each configuration according to the last subframe L in the coordination subframe, the subframe position of the PHICH resource corresponding to the PUSCH:

Because for different configurations, positions and quantities of uplink subframes are different, during specific bundling, there may be multiple cases. The following gives a description according to different bundling cases.

Manner 1: All uplink subframes in one radio frame are bundled to form one bundle subframe, and each bundle subframe corresponds to one HARQ process. Specific implementation may be:

if an uplink-downlink subframe configuration is 0, when special subframes 1 and 6 in a radio frame are bundled with subframes 2, 3, 4, 7, 8, and 9 in the radio frame, determining that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determining that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determining that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determining that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determining that the PHICH resource is located in the K^{th} subframe after the last subframe L, where L=2 and K=5, 15, or 25; or

if an uplink-downlink subframe configuration is 6, when special subframes 1 and 6 in a radio frame are bundled with subframes 2, 3, 4, 7, and 8 in the radio frame, determining that the PHICH resource is located in the K^{th} subframe after the last subframe L, where L=8 and K=17.

Manner 2: When one radio frame includes two special subframes, each special subframe may form one bundle subframe, and bundle subframes separately correspond to different HARQ processes, specific implementation may be:

1. If an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the determining, according to the last subframe L in the coordination subframe, the subframe position of the PHICH resource corresponding to the PUSCH includes:

a first PHICH resource corresponding to the first bundle frame is located in the Kth subframe after the last subframe L, where L=2 and K1=4; and

a second PHICH resource corresponding to the second bundle frame is located in the Kth subframe after the last subframe L, where L=7 and K2=4.

2. If an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the determining, according to the last subframe L in the coordination subframe, the subframe position of the PHICH resource corresponding to the PUSCH includes:

a first PHICH resource corresponding to the first bundle frame is located in the K^{th} subframe after the last subframe L, where L=3 and K=6;

a second PHICH resource corresponding to the second bundle frame is located in the K^{th} subframe after the last subframe L, where L=2 and K=6; and

a third PHICH resource corresponding to the third bundle frame is located in the K^{th} subframe after the last subframe L, where L=4 and K=6.

After the base station determines the subframe position of the PHICH resource corresponding to the PUSCH, PHICH information corresponding to the base station may be determined uniquely by using the following formula according to the PHICH group number and an orthogonal sequence number (n_{PHICH}^{group}, n_{PHICH}^{seq}) of the PHICH in the group and is separated:

n_{PHICH}^{group}=(I_{PRB}_{_}_{RA}+n_{DMRS})mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS})mod 2N_{SF}^{PHICH}

In the method provided in this embodiment of the present invention, a time frequency domain of the PHICH resource is further determined. In the method, the PHICH group number of the PHICH resource is further determined according to the subframe position, which specifically includes:

determining, according to the subframe position corresponding to the PHICH resource and by using a PHICH group number indication factor I_{PHICH}, the PHICH group number corresponding to the PUSCH.

In a specific instance, the determining the PHICH group number of the PHICH resource according to the subframe position includes:

1. when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determining, by using the determined I_{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determining that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determining, by using the determined I_{PHICH,} the PHICH group number corresponding to the PUSCH; and

2. when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 6 and 8 are 1, and I_{PHICH} corresponding to another subframe in the radio frame of the current special subframe except the subframes 6 and 8 is 0, and determining, by using the determined I_{PHICH}, the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determining that PHICH group number indication factors I_{PHICH} corresponding to subframes 1 and 4 are 1, and I_{PHICH} corresponding to another subframe in the radio frame of the current special subframe except the subframes 1 and 4 is 0, and determining, by using the determined I_{PHICH}, the PHICH group number corresponding to the PUSCH.

### Embodiment 5

As shown in FIG. 5, for the method provided in Embodiment 1, this embodiment of the present invention further provides user equipment 500. The user equipment includes:

a sending unit 501, configured to send a PUSCH in a current special subframe;

a determining module 502, configured to determine, according to an uplink resource used to transmit the PUSCH, a PHICH resource corresponding to the PUSCH, where the uplink resource used to transmit the PUSCH includes the current special subframe; and

a receiving unit 503, configured to receive a PHICH on the determined PHICH resource.

The determining a PHICH resource corresponding to the PUSCH includes: determining a subframe position of the resource and a PHICH group number of the resource. Therefore, for content needing to be determined, the determining unit 502 specifically includes:

a subframe position determining module, configured to determine, according to the uplink resource used to transmit the PUSCH, the subframe position of the PHICH resource corresponding to the PUSCH; and

a resource group number determining module, configured to determine the PHICH group number of the PHICH resource according to the subframe position, and determine, according to the subframe position and the PHICH group number, the PHICH resource corresponding to the PUSCH.

I. When a subframe of the uplink resource used to transmit the PUSCH is only the current special subframe, when the UE determines, according to the uplink resource used to transmit the PUSCH, the subframe position of the PHICH resource corresponding to the PUSCH, the subframe position determining module is further configured to:

when an uplink-downlink subframe configuration is 0 and the current special subframe is a subframe n, determine that the PHICH resource is located in the K^{th} subframe after the current special subframe n, where when n=1 or 6, K=5; or when n=1 or 6, K=10; or

when an uplink-downlink subframe configuration is 1 and the current special subframe is a subframe n, determine that the PHICH resource is located in the ^{Kt h} subframe after the current special subframe n, where when n=1 or 6, K=4; when n=1 or 6, K=5; or when n=1 or 6, K=8; or

when an uplink-downlink subframe configuration is 2 and the current special subframe is a subframe n, determine that the PHICH resource is located in the ^{Kt h} subframe after the current special subframe n, where when n=1 or 6, K=4; when n=1 or 6, K=5; when n=1 or 6, K=7; or when n=1 or 6, K=8; or

when an uplink-downlink subframe configuration is 3 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 6 and the current special subframe is a subframe n, determine that the PHICH resource is located in the K^{th} subframe after the current special subframe n, where

when n=1 or 6, K=4;

when n=1 or 6, K=5;

when n=1 or 6, K=8;

when n=1 or 6, K=9; or

when n=1 or 6, K=10.

II. The existing protocol Rel-11 further specifies: an uplink PUSCH may transmitted in a subframe bundling (subframe bundling or TTI bundling) manner. The resource used to transmit the PUSCH may be a bundle frame; therefore, when the subframe position determining module determines the subframe position of the PHICH resource corresponding to the PUSCH, specific implementation may be:

when the subframe of the uplink resource used to transmit the PUSCH includes the current special subframe and another subframe, the subframe position determining module is further configured to determine, according to the coordination subframe, the subframe position of the PHICH resource corresponding to the PUSCH.

In addition, the subframe position determining module is further configured to determine, by using at least one uplink subframe, in a radio frame of the current special subframe, included in the coordination subframe and/or another special subframe, in the radio frame except the current special subframe, included in the coordination subframe, the subframe position of the PHICH resource corresponding to the PUSCH.

Optionally, to comprehensively consider a transmission delay and eNB processing time and consider a transmission delay and UE processing time, the subframe position determining module is further configured to determine, according to the last subframe L in the coordination subframe, the subframe position of the PHICH resource corresponding to the PUSCH.

Specifically, with reference to seven uplink-downlink subframe configurations that are defined in the LTE TDD system and that are shown in Table 1, in each configuration, there are multiple manners in which the subframe position determining module determines, according to the last subframe L in the coordination subframe, the subframe position of the PHICH resource corresponding to the PUSCH, which may be specifically:

Manner 1: When all uplink subframes and special subframes in one radio frame are bundled to form one bundle subframe, and each bundle subframe corresponds to one HARQ process, the subframe position determining module is further configured to:

if an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determine that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determine that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determine that the PHICH resource is located in the K^{th} subframe after the last subframe L, where L=2 and K=5, 15, or 25; or

if an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, where L=8 and K=17.

Manner 2: When one radio frame includes two special subframes, each special subframe may form one bundle subframe, and bundle subframes separately correspond to different HARQ processes, which specifically includes:

If an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the subframe position determining module is further configured to:

determine that a first PHICH resource corresponding to the first bundle frame is located in the K1^{th} subframe after the last subframe L, where L=2 and K1=4; and

determine that a second PHICH resource corresponding to the second bundle frame is located in the K2^{th} subframe after the last subframe L, where L=7 and K2=4.

If an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the subframe position determining module is further configured to:

determine that a first PHICH resource corresponding to the first bundle frame is located in the K^{th} subframe after the last subframe L, where L=3 and K=6;

determine that a second PHICH resource corresponding to the second bundle frame is located in the K^{th} subframe after the last subframe L, where L=2 and K=6; and

determine that a third PHICH resource corresponding to the third bundle frame is located in the K^{th} subframe after the last subframe L, where L=4 and K=6.

After the UE determines the subframe position of the PHICH resource corresponding to the PUSCH, PHICH information corresponding to the PUSCH may be determined uniquely by using the following formula according to the PHICH group number and an orthogonal sequence number (n_{PHICH}^{group}, n_{PHICH}^{seq}) of the PHICH in the group and is separated:

n_{PHICH}^{group}=(I_{PRB}_{_}_{RA}+n_{DMRS})mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS})mod 2N_{SF}^{PHICH}

In the method provided in this embodiment of the present invention, a time frequency domain of the PHICH resource is further determined, and the resource group number determining module is further configured to determine, according to the subframe position corresponding to the PHICH resource and by using a PHICH group number indication factor I_{PHICH}, the PHICH group number corresponding to the PUSCH.

Optionally, the resource group number determining module is further configured to:

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determine, by using the determined I_{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determine, by using the determined I_{PHICH}, the PHICH group number corresponding to the PUSCH.

Optionally, the resource group number determining module is further configured to:

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 6 and 8 are 1, and I_{PHICH} corresponding to another subframe in the radio frame of the current special subframe except the subframes 6 and 8 is 0, and determine, by using the determined I_{PHICH}, the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 1 and 4 are 1, and I_{PHICH} corresponding to another subframe in the radio frame of the current special subframe except the subframes 1 and 4 is 0, and determine, by using the determined I_{PHICH}, the PHICH group number corresponding to the PUSCH.

### Embodiment 6

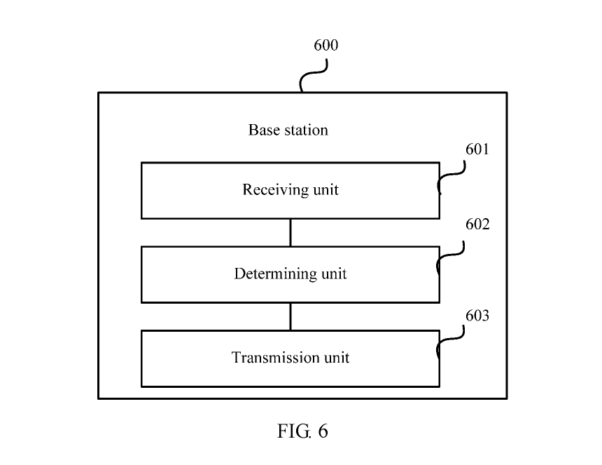

As shown in FIG. 6, based on the method provided in Embodiment 4, this embodiment of the present invention further provides a base station 600. The base station includes:

a receiving unit 601, configured to receive a PUSCH in a current special subframe;

a determining module 602, configured to determine, according to an uplink resource used to receive the PUSCH, a PHICH resource corresponding to the PUSCH, where the uplink resource includes the current special subframe; and

a transmission unit 603, configured to transmit a PHICH on the determined PHICH resource.

The PHICH resource includes two parts: a subframe position of the PHICH resource and a PHICH group number of the PHICH resource. Therefore, the determining unit 602 specifically includes:

a subframe position determining module, configured to determine, according to the uplink resource used to receive the PUSCH, the subframe position of the PHICH resource corresponding to the PUSCH; and

a resource group number determining module, configured to determine the PHICH group number of the PHICH resource according to the subframe position, and determine, according to the subframe position and the PHICH group number, the PHICH resource corresponding to the PUSCH.

I. When the subframe of the uplink resource used to transmit the PUSCH is only the current special subframe, and the subframe position determining module determines, according to the uplink resource used to receive the PUSCH, the subframe position of the PHICH resource corresponding to the PUSCH, the subframe position determining module is further configured to:

when an uplink-downlink subframe configuration is 0 and the current special subframe is a subframe n, determine that the PHICH resource is located in the K^{th} subframe after the current special subframe n, where

when n=1 or 6, K=5; or

when n=1 or 6, K=10; or

when an uplink-downlink subframe configuration is 1 and the current special subframe is a subframe n, determine that the PHICH resource is located in the K^{th} subframe after the current special subframe n, where

when n=1 or 6, K=4;

when n=1 or 6, K=5; or

when n=1 or 6, K=8; or

when an uplink-downlink subframe configuration is 2 and the current special subframe is a subframe n, determine that the PHICH resource is located in the K^{th} subframe after the current special subframe n, where

when n=1 or 6, K=4;

when n=1 or 6, K=5;

when n=1 or 6, K=7; or

when n=1 or 6, K=8; or

when an uplink-downlink subframe configuration is 3 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 4 and the current special subframe is a subframe n, determine that the PHICH resource is located in the K^{th} subframe after the current special subframe n, where when n=1, K=4, 5, 6, 7, 8, or 9; or

when an uplink-downlink subframe configuration is 5 and the current special subframe is a subframe n, determine that the PHICH resource is located in the ^{Kt h} subframe after the current special subframe n, where when n=1, K=4, 5, 6, 7, 8, or 9; or

when an uplink-downlink subframe configuration is 6 and the current special subframe is a subframe n, determine that the PHICH resource is located in the K^{th} subframe after the current special subframe n, where

when n=1 or 6, K=4;

when n=1 or 6, K=5;

when n=1 or 6, K=8;

when n=1 or 6, K=9; or

when n=1 or 6, K=10.

II. When the subframe of the uplink resource used to transmit the PUSCH includes the current special subframe and another subframe, that is, when the subframe of the uplink resource used to transmit the PUSCH includes the current special subframe and a coordination subframe bundled with the current special subframe, the subframe position determining module is further configured to determine, according to the coordination subframe, the subframe position of the PHICH resource corresponding to the PUSCH.

During specific implementation, the subframe position determining module is further configured to determine, by using at least one uplink subframe, in a radio frame of the current special subframe, included in the coordination subframe and/or another special subframe in the radio frame except the current special subframe, the subframe position of the PHICH resource corresponding to the PUSCH.

Optionally, to comprehensively consider a transmission delay and eNB processing time and consider a transmission delay and UE processing time, in this embodiment of the present invention, the subframe position determining module is further configured to determine, according to the last subframe L in the coordination subframe, the subframe position of the PHICH resource corresponding to the PUSCH.

Specifically, with reference to the seven uplink-downlink subframe configurations that are defined in the LTE (LTE, Long Term Evolution) TDD system and that are shown in Table 1, the following describes in detail an implementable solution of determining, in each configuration according to the last subframe L in the coordination subframe, the subframe position of the PHICH resource corresponding to the PUSCH:

Because for different configurations, positions and quantities of uplink subframes are different, during specific bundling, there may be multiple cases. The following gives a description according to different bundling cases.

Manner 1: When all uplink subframes in one radio frame are bundled to form one bundle subframe, and each bundle subframe corresponds to one HARQ process, the subframe position determining module is further configured to:

if an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, where L=9 and K=6; or

if an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, where L=8 and K=6; or

if an uplink-downlink subframe configuration is 2, when special subframes 1 and 6 in a radio frame are bundled with subframes 2 and 7 in the radio frame, determine that the PHICH resource is located in the K^{th} subframe after the last subframe L, where L=7 and K=6, 9, or 19; or

if an uplink-downlink subframe configuration is 3, when a special subframe 1 in a radio frame is bundled with subframes 2, 3, and 4 in the radio frame, determine that the PHICH resource is located in the K^{th} subframe after the last subframe L, where L=4 and K=16; or

if an uplink-downlink subframe configuration is 5, when a special subframe 1 in a radio frame is bundled with a subframe 2 in the radio frame, determine that the PHICH resource is located in the K^{th} subframe after the last subframe L, where L=2 and K=5, 15, or 25; or

if an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, where L=8 and K=17.

Manner 2: When one radio frame includes two special subframes, each special subframe may form one bundle subframe, and bundle subframes separately correspond to different HARQ processes, specific implementation may be:

1. If an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the subframe position determining module is further configured to:

determine that a first PHICH resource corresponding to the first bundle frame is located in the K1^{th} subframe after the last subframe L, where L=2 and K1=4; and

determine that a second PHICH resource corresponding to the second bundle frame is located in the K2^{th} subframe after the last subframe L, where L=7 and K2=4.

2. If an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the subframe position determining module is further configured to:

determine that a first PHICH resource corresponding to the first bundle frame is located in the K^{th} subframe after the last subframe L, where L=3 and K=6;

determine that a second PHICH resource corresponding to the second bundle frame is located in the K^{th} subframe after the last subframe L, where L=2 and K=6; and

determine that a third PHICH resource corresponding to the third bundle frame is located in the K^{th} subframe after the last subframe L, where L=4 and K=6.

After the base station determines the subframe position of the PHICH resource corresponding to the PUSCH, the PHICH information corresponding to the base station may be determined uniquely by using the following formula according to the PHICH group number and an orthogonal sequence number (n_{PHICH}^{group}, n_{PHICH}^{seq}) of the PHICH in the group and is separated:

n_{PHICH}^{group}=(I_{PRB}_{_}_{RA}+n_{DMRS})mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS})mod 2N_{SF}^{PHICH}

In the method provided in this embodiment of the present invention, a time frequency domain of the PHICH resource is further determined, and the resource group number determining module is further configured to determine, according to the subframe position corresponding to the PHICH resource and by using a PHICH group number indication factor I_{PHICH}, the PHICH group number corresponding to the PUSCH.

In a specific instance, when the base station determines the PHICH group number of the PHICH resource according to the subframe position, the resource group number determining module is further configured to: when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 2, 4, 7, and 9 are 1, and I_{PHICH} corresponding to another subframe in the radio frame of the current special subframe except the subframes 2, 4, 7, and 9 is 0, and determine, by using the determined I ^{PHICH}, the PHICH group number corresponding to the PUSCH; or

when an uplink-downlink subframe configuration is 0, the current special subframe is a subframe n, and the PHICH resource is located in the K^{th} subframe after the special subframe n, where when n=1 or 6, K=5, determine that PHICH group number indication factors I_{PHICH} corresponding to subframes 1, 6, 4, and 9 are 1, and I_{PHICH} corresponding to another subframe in the radio frame of the current special subframe except the subframes 1, 6, 4, and 9 is 0, and determine, by using the determined I_{PHICH}, the PHICH group number corresponding to the PUSCH.

Optionally, the resource group number determining module is further configured to:

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 6 and 8 are 1, and I_{PHICH} corresponding to another subframe in the radio frame of the current special subframe except the subframes 6 and 8 is 0, and determine, by using the determined I_{PHICH,} the PHICH group number corresponding to the PUSCH; or

when an uplink-downlink subframe configuration is 6, the current special subframe is a subframe n, and the PHICH resource is located in the K^{th} subframe after the special subframe n, where when n=1 or 6, K=4, determine that PHICH group number indication factors I_{PHICH} corresponding to subframes 1 and 4 are 1, and I_{PHICH} corresponding to another subframe in the radio frame of the current special subframe except the subframes 1 and 4 is 0, and determine, by using the determined I_{PHICH}, the PHICH group number corresponding to the PUSCH.

One or more technical solutions of the embodiments of this application have at least the following technical effects:

The method provided in the embodiments of the present invention resolves the problem in the prior art that when a special subframe (in a separate or bundling manner) is used to transmit an uplink PUSCH, there is no specific solution to determine a receiving position of a downlink PHICH corresponding to an uplink PUSCH.

In addition, when the receiving position of the downlink PHICH is determined, a method for adjusting a PHICH group number corresponding to a PHICH resource is further provided, thereby providing a method for resolving a conflict between a PHICH resource corresponding to a newly determined PUSCH and an original configuration.

It may be clearly understood by a person skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation.

For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) or a processor (processor) to perform all or some of the steps of the methods described in the embodiments of the present application. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely used to describe in detail the technical solutions of the present application. The descriptions of the foregoing embodiments are merely intended to help understand the method and core idea of the present invention, and shall not be construed as a limitation to the present invention. Any variation or replacement readily figured out by a person skilled in the art within the technical scope disclosed in the present invention shall fall within the protection scope of the present invention.

What is claimed is:

1. A control channel resource allocation method, wherein the method comprises:
sending, by user equipment (UE), a physical uplink shared channel (PUSCH) in a current special subframe;
determining, by the UE according to an uplink resource used to transmit the PUSCH, a physical hybrid automatic repeat request indicator channel (PHICH) resource corresponding to the PUSCH, wherein the uplink resource used to transmit the PUSCH comprises the current special subframe; and
receiving, by the UE, a PHICH on the determined PHICH resource.

2. The method according to claim 1, wherein the determining, by the UE according to an uplink resource used to transmit the PUSCH, a PHICH resource corresponding to the PUSCH comprises:
determining, by the UE according to the uplink resource used to transmit the PUSCH, a subframe position of the PHICH resource corresponding to the PUSCH; and
determining a PHICH group number of the PHICH resource according to the subframe position, and determining, according to the subframe position and the PHICH group number, the PHICH resource corresponding to the PUSCH.

3. The method according to claim 2, wherein when a subframe of the uplink resource used to transmit the PUSCH is only the current special subframe, the determining, by the UE according to the uplink resource used to transmit the PUSCH, a subframe position of the PHICH resource corresponding to the PUSCH comprises at least one of the following:
when an uplink-downlink subframe configuration is 0 and the current special subframe is a subframe n, determining that the PHICH resource is located in the K^{th} subframe after the current special subframe n, wherein when n=1 or 6, K=5; or when n=1 or 6, K=10;
when an uplink-downlink subframe configuration is 1 and the current special subframe is a subframe n, determining that the PHICH resource is located in the K^{th} subframe after the current special subframe n, wherein when n=1 or 6, K=4; when n=1 or 6, K=5; or when n=1 or 6, K =8;
when an uplink-downlink subframe configuration is 2 and the current special subframe is a subframe n, determining that the PHICH resource is located in the K^{th} subframe after the current special subframe n, wherein when n=1 or 6, K=4; when n=1 or 6, K=5; when n=1 or 6, K=7;
or when n=1 or 6, K=8;
when an uplink-downlink subframe configuration is 3 and the current special subframe is a subframe n, determining that the PHICH resource is located in the K^{th} subframe after the current special subframe n, wherein when n=1, K=4, 5, 6, 7, 8, or 9;
when an uplink-downlink subframe configuration is 4 and the current special subframe is a subframe n, determining that the PHICH resource is located in the K^{th} subframe after the current special subframe n, wherein when n=1, K=4, 5, 6, 7, 8, or 9;
when an uplink-downlink subframe configuration is 5 and the current special subframe is a subframe n, determining that the PHICH resource is located in the K^{th} subframe after the current special subframe n, wherein when n=1, K=4, 5, 6, 7, 8, or 9; and
when an uplink-downlink subframe configuration is 6 and the current special subframe is a subframe n, determining that the PHICH resource is located in the K^{th} subframe after the current special subframe n, wherein
when n=1 or 6, K=4;
when n=1 or 6, K=5;
when n=1 or 6, K=8;
when n=1 or 6, K=9; or
when n=1 or 6, K=10.

4. The method according to claim 2, wherein when a subframe of the uplink resource used to transmit the PUSCH comprises the current special subframe and a coordination subframe bundled with the current special subframe, the determining, by the UE according to the uplink resource used to transmit the PUSCH, a subframe position of the PHICH resource corresponding to the PUSCH comprises:
determining, according to the coordination subframe, the subframe position of the PHICH resource corresponding to the PUSCH.

5. The method according to claim 4, wherein the coordination subframe comprises at least one uplink subframe in a radio frame of the current special subframe and/or another special subframe in the radio frame except the current special subframe.

6. The method according to claim 5, wherein the determining, by the UE according to the uplink resource used to transmit the PUSCH, a subframe position of the PHICH resource corresponding to the PUSCH comprises:
determining, according to the last subframe L in the coordination subframe, the subframe position of the PHICH resource corresponding to the PUSCH.

7. The method according to claim 6, wherein the determining, according to the last subframe L in the coordination subframe, the subframe position of the PHICH resource corresponding to the PUSCH comprises at least one of the following:
if an uplink-downlink subframe configuration is 0, when special subframes 1 and 6 in a radio frame are bundled with subframes 2, 3, 4, 7, 8, and 9 in the radio frame, determining that the PHICH resource is located in the K^{th} subframe after the last subframe L, wherein L=9 and K=6;
if an uplink-downlink subframe configuration is 1, when special subframes 1 and 6 in a radio frame are bundled with subframes 2, 3, 7, and 8 in the radio frame, determining that the PHICH resource is located in the K^{th} subframe after the last subframe L, wherein L=8 and K=6;
if an uplink-downlink subframe configuration is 2, when special subframes 1 and 6 in a radio frame are bundled with subframes 2 and 7 in the radio frame, determining that the PHICH resource is located in the K^{th} subframe after the last subframe L, wherein L=7 and K=6, 9, or 19;
if an uplink-downlink subframe configuration is 3, when a special subframe 1 in a radio frame is bundled with subframes 2, 3, and 4 in the radio frame, determining that the PHICH resource is located in the K^{th} subframe after the last subframe L, wherein L=4 and K=16;
if an uplink-downlink subframe configuration is 5, when a special subframe 1 in a radio frame is bundled with a subframe 2 in the radio frame, determining that the PHICH resource is located in the K^{th} subframe after the subframe 2, wherein K=5, 15, or 25; and
if an uplink-downlink subframe configuration is 6, when special subframes 1 and 6 in a radio frame are bundled with subframes 2, 3, 4, 7, and 8 in the radio frame, determining that the PHICH resource is located in the K^{th} subframe after the last subframe L, wherein L=8 and K=17.

8. The method according to claim 6, wherein if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the determining, according to the last subframe L in the coordination subframe, the subframe position of the PHICH resource corresponding to the PUSCH comprises:
determining a first PHICH resource corresponding to the first bundle frame is located in the K1^{th} subframe after the last subframe L, wherein L=2 and K1=4; and
determining a second PHICH resource corresponding to the second bundle frame is located in the K2^{th} subframe after the last subframe L, wherein L=7 and K2=4.

9. The method according to claim 6, wherein if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the determining, according to the last subframe L in the coordination subframe, the subframe position of the PHICH resource corresponding to the PUSCH comprises:
a first PHICH resource corresponding to the first bundle frame is located in the K^{th} subframe after the last subframe L, wherein L=3 and K=6;
a second PHICH resource corresponding to the second bundle frame is located in the K^{th} subframe after the last subframe L, wherein L=2 and K=6; and
a third PHICH resource corresponding to the third bundle frame is located in the K^{th} subframe after the last subframe L, wherein L=4 and K=6.

10. The method according to claim 2, wherein the determining a PHICH group number of the PHICH resource according to the subframe position comprises:
determining, according to the subframe position corresponding to the PHICH resource and by using a PHICH group number indication factor I_{PHICH} , the PHICH group number corresponding to the PUSCH.

11. User equipment, wherein the user equipment comprises:
a transmitter, configured to send a physical uplink shared channel (PUSCH) in a current special subframe;
a processor, configured to determine, according to an uplink resource used to transmit the PUSCH, a physical hybrid automatic repeat request indicator channel (PHICH) resource corresponding to the PUSCH, wherein the uplink resource used to transmit the PUSCH comprises the current special subframe; and
a receiver, configured to receive a PHICH on the determined PHICH resource.

12. The user equipment according to claim 11, wherein the processor is configured to:
determine, according to the uplink resource used to transmit the PUSCH, a subframe position of the PHICH resource corresponding to the PUSCH; and
determine a PHICH group number of the PHICH resource according to the subframe position, and determine, according to the subframe position and the PHICH group number, the PHICH resource corresponding to the PUSCH.

13. The user equipment according to claim 12, wherein when a subframe of the uplink resource used to transmit the PUSCH is only the current special subframe, the processor is configured to perform one of the following:
when an uplink-downlink subframe configuration is 0 and the current special subframe is a subframe n, determine that the PHICH resource is located in the K^{th} subframe after the current special subframe n, wherein when n=1 or 6, K=5; or when n=1 or 6, K=10;
when an uplink-downlink subframe configuration is 1 and the current special subframe is a subframe n, determine that the PHICH resource is located in the K^{th} subframe after the current special subframe n, wherein when n=1 or 6, K=4; when n=1 or 6, K=5; or when n=1 or 6, K =8;
when an uplink-downlink subframe configuration is 2 and the current special subframe is a subframe n, determine that the PHICH resource is located in the K^{th} subframe after the current special subframe n, wherein when n=1 or 6, K=4; when n=1 or 6, K=5; when n=1 or 6, K=7; or when n=1 or 6, K=8;
when an uplink-downlink subframe configuration is 3 and the current special subframe is a subframe n, determine that the PHICH resource is located in the K^{th} subframe after the current special subframe n, wherein when n=1, K=4, 5, 6, 7, 8, or 9;
when an uplink-downlink subframe configuration is 4 and the current special subframe is a subframe n, determine that the PHICH resource is located in the K^{th} subframe after the current special subframe n, wherein when n=1, K=4, 5, 6, 7, 8, or 9;
when an uplink-downlink subframe configuration is 5 and the current special subframe is a subframe n, determine that the PHICH resource is located in the K^{th} subframe after the current special subframe n, wherein when n=1, K=4, 5, 6, 7, 8, or 9; and
when an uplink-downlink subframe configuration is 6 and the current special subframe is a subframe n, determine that the PHICH resource is located in the K^{th} subframe after the current special subframe n, wherein
when n=1 or 6, K=4;
when n=1 or 6, K=5;
when n=1 or 6, K=8;
when n=1 or 6, K=9; or
when n=1 or 6, K=10.

14. The user equipment according to claim 12, wherein when a subframe of the uplink resource used to transmit the PUSCH comprises the current special subframe and a coordination subframe bundled with the current special subframe, the processor is configured to determine, according to the coordination subframe, the subframe position of the PHICH resource corresponding to the PUSCH.

15. The user equipment according to claim 14, wherein the processor is configured to determine, by using at least one uplink subframe, in a radio frame of the current special subframe, comprised in the coordination subframe and/or another special subframe, in the radio frame except the current special subframe, comprised in the coordination subframe, the subframe position of the PHICH resource corresponding to the PUSCH.

16. The user equipment according to claim 15, wherein the processor is configured to determine, according to the last subframe L in the coordination subframe, the subframe position of the PHICH resource corresponding to the PUSCH.

17. The user equipment according to claim 16, wherein the processor is configured to perform one of the following:
if an uplink-downlink subframe configuration is 0, when special subframes 1 and 6 in a radio frame are bundled with subframes 2, 3, 4, 7, 8, and 9 in the radio frame, determine that the PHICH resource is located in the K^{th} subframe after the last subframe L, wherein L=9 and K=6;
if an uplink-downlink subframe configuration is 1, when special subframes 1 and 6 in a radio frame are bundled with subframes 2, 3, 7, and 8 in the radio frame, determine that the PHICH resource is located in the K^{th} subframe after the last subframe L, wherein L=8 and K=6;
if an uplink-downlink subframe configuration is 2, when special subframes 1 and 6 in a radio frame are bundled with subframes 2 and 7 in the radio frame, determine that the PHICH resource is located in the K^{th} subframe after the last subframe L, wherein L=7 and K=6, 9, or 19;
if an uplink-downlink subframe configuration is 3, when a special subframe 1 in a radio frame is bundled with subframes 2, 3, and 4 in the radio frame, determine that the PHICH resource is located in the K^{th} subframe after the last subframe L, wherein L=4 and K=16;
if an uplink-downlink subframe configuration is 5, when a special subframe 1 in a radio frame is bundled with a subframe 2 in the radio frame, determine that the PHICH resource is located in the K^{th} subframe after the last subframe L, wherein L=2 and K=5, 15, or 25; and
if an uplink-downlink subframe configuration is 6, when special subframes 1 and 6 in a radio frame are bundled with subframes 2, 3, 4, 7, and 8 in the radio frame, determine that the PHICH resource is located in the K^{th} subframe after the last subframe L, wherein L=8 and K=17.

18. The user equipment according to claim 16, wherein if an uplink-downlink subframe configuration is 2, when a special subframe 1 in a radio frame and a subframe 2 in the radio frame are bundled to form a first bundle frame, and a special subframe 6 in the radio frame and a subframe 7 in the radio frame are bundled to form a second bundle frame, the processor is configured to:
determine that a first PHICH resource corresponding to the first bundle frame is located in the K1^{th} subframe after the last subframe L, wherein L=2 and K1=4; and
determine that a second PHICH resource corresponding to the second bundle frame is located in the K^{th} subframe after the last subframe L, wherein L=7 and K2=4.

19. The user equipment according to claim 16, wherein if an uplink-downlink subframe configuration is 3, when a special subframe 1 in a radio frame and subframes 2 and 3 in the radio frame are bundled to form a first bundle frame, a subframe 4 in the radio frame, a special subframe 1 in a next radio frame, and a subframe 2 in the next radio frame are bundled to form a second bundle frame, and subframes 3 and 4 in the next radio frame are bundled to form a third bundle frame, the processor is configured to:
determine that a first PHICH resource corresponding to the first bundle frame is located in the K^{th} subframe after the last subframe L, wherein L=3 and K=6;
determine that a second PHICH resource corresponding to the second bundle frame is located in the K^{th} subframe after the last subframe L, wherein L=2 and K=6; and
determine that a third PHICH resource corresponding to the third bundle frame is located in the K^{th} subframe after the last subframe L, wherein L=4 and K=6.

20. The user equipment according to claim 12, wherein the processor is configured to determine, according to the subframe position corresponding to the PHICH resource and by using a PHICH group number indication factor I_{PHICH}, the PHICH group number corresponding to the PUSCH.
